(19) United States
(12) Patent Application Publication
(10) Pub. No.: US 2013/0297431 A1
(43) Pub. Date: Nov. 7, 2013

(54) METHOD AND APPARATUS FOR CREATING A VALUE-BEARING INSTRUMENT WHERE THE DESIGN ATTRIBUTES COMPLIMENT/MATCH A PRODUCT OR SERVICE

(71) Applicants: Robert M. Deubell, Loveland, OH (US); Robert A. Adams, Loveland, OH (US)

(72) Inventors: Robert M. Deubell, Loveland, OH (US); Robert A. Adams, Loveland, OH (US)

(21) Appl. No.: 13/887,084

(22) Filed: May 3, 2013

Related U.S. Application Data
(60) Provisional application No. 61/687,899, filed on May 3, 2012.

(51) Int. Cl. G06Q 20/18

(52) U.S. Cl. CPC G06Q 20/18
USPC 705/17; 705/16; 705/23; 705/21

(57) ABSTRACT

A method of generating a gift card comprising: (a) receiving indicia corresponding to at least one of a product indicia representative of a particular product and a service indicia representative of a particular service; (b) making a gift card graphic available to the processing device that matches at least one of the product indicia and the service indicia; (c) merging the gift card graphics with a gift card template to create a virtual gift card; (d) recording the virtual gift card with a memory accessible by a kiosk that includes a gift card printer; and, (e) generating a receipt uniquely corresponding to at least one of the virtual gift card and a tangible gift card.

### CROSS REFERENCE TO RELATED APPLICATIONS

The present application claims the benefit of U.S. Provisional Patent Application Ser. No. 61/687,899, filed May 3, 2012 and titled, “METHOD AND APPARATUS FOR CREATING A VALUE-BEARING INSTRUMENT WHERE THE DESIGN ATTRIBUTES COMPLIMENT/MATCH A GREETING CARD OR OTHER RETAIL PRODUCT,” the disclosure of which is hereby incorporated by reference.

### RELATED ART

1. Field of the Invention

The present invention pertains to a self-service kiosk that suggests to a user a value-bearing instrument, such as a gift card, that has a matching or complimentary design to a particular retail product the user purchased or intends to purchase. In addition, the present invention may include the gift card, a virtual gift card, or other instrument of value that is associated with a specific good or service, or style of good or service.

2. Brief Discussion of Related Art

Greeting cards are given today for an occasion and frequently are accompanied by a separately purchased gift from the purchaser of the greeting card to the recipient. Sometimes these greeting cards have an insert for money or a gift card that is purchased separately to accompany the greeting card (e.g., graduation greeting cards, First Communion, etc.). In cases where the greeting card includes a slot for a gift card, the gift card does not match or compliment the greeting card, or vice versa, thereby losing some of the emotional appeal of the greeting card. [symbol] themselves if picking out a retail item. These factors may include: what is the right item size for the recipient, what style will the recipient like; and, what color will the recipient like the best. Frequently, there is a perceived risk on the part of the giver that if he chooses the wrong size or color gift, the recipient will be burdened with needing to return the gift, which causes the recipient undue effort and possible embarrassment by not accepting the gift “as-is.” This is one of the motivating factors around the decision of the gift giver to give a gift card as an alternative to purchasing an actual product from a retailer. But a gift card may be perceived by the recipient as less thoughtful, losing some of the emotional reward that an actual product gift may have.

### INTRODUCTION TO THE INVENTION

The present invention is directed to methods and devices whereby a user can create a matching personalized financial instrument (i.e. open-loop gift card, closed-loop gift card, prepaid card, virtual card, etc.) to a greeting card or other retail product the user purchases. The system (i.e., a kiosk or other self-service device) includes software that may access preloaded or database accessed gift card design elements that match the retail service or a retail product (e.g., a greeting card). In the alternative, the system may include means to photograph and/or transfer at least a portion of a photographed image onto a gift card.

The user may initiate an exemplary process by selecting a retail product or service he wishes to give to a recipient. The user may then be instructed to scan a barcode (e.g., a universal product code) found on the retail product or service at the kiosk using a built-in barcode scanner. The identification of the barcode may be linked in the system to a matching gift card design that resides either at the kiosk or in a database remotely accessible via the kiosk.

In another aspect of the invention, the user can photograph a retail product's barcode, service code, product image, or other type of identifier used to identify the product or service. In this aspect of the invention, instead of bringing the retail product to the kiosk, the user's mobile device may be used to capture the identification of the product/service that the user wishes to have the system suggest matching/complimentary gift card designs or, in the alternative, allow the user to design his own gift card. The user holds his phone proximate a reader/scanner associated with the kiosk or connects wirelessly to the kiosk in order that the kiosk may recognize the identification of the product and formulate or propose a gift card design corresponding to the intended product.

In another aspect of the invention, the retail product or service may have an RFID tag associated with it. The kiosk may be outfitted with an RFID tag reader and the retail product/service is identified by the system via this RFID tag. Once the retail product/service code has been identified by the system, matching gift cards may then be presented to the user for further customization.

Once the retail product or service is identified at the kiosk via barcode, RFID, image, or other identification method, the system searches for matching/complimentary gift card designs via one or more databases. Alternatively, or in addition, the system may generate a gift card design from information obtained directly or indirectly from the kiosk user. The matching gift card is then presented virtually to the kiosk user for viewing on the kiosk screen, which may be a touchscreen. The user can then add design elements, including a personalized message to the recipient, with recommended fonts matching the card, a card specific predefined quote, or matching/complimentary images to the gift card, where each of these design elements are also suggested to the user based on the gift card design. The user can also determine the dollar amount he wishes to load onto the gift card. Subsequently, the user makes payment at the kiosk using a credit card, debit card, cash, smart card, mobile wallet, etc., for payment processing and within seconds the gift card is printed. The gift card can either be outputted at the kiosk or in a central store location where the user then picks it up by showing a receipt printed at the kiosk. Alternatively, the gift card may be outputted as a virtual gift card and electronically communicated to an intended recipient or the gift card giver.

In one exemplary embodiment when creating a gift card to match a product gift (such as a greeting card), the user may affix the matching gift card to or in the greeting card. Certain greeting cards may have a gift card holder designed into the inside of the card, which can be precut strips for the corners to be inserted or alternatively sticky backing protective strips pre-applied to the greeting cards for removal by the user from the inside of the greeting card. Other options include the use of sticky material applied to the back of the gift card or greeting card by the user and affixed by the user.

In another aspect of the invention, users can access an application or webpage from their mobile phone or computer and create a gift card design incorporating graphic elements either or both from a provided library and from the user's own images including photographs, logos, artwork, signatures, and other images. After the user selects and/or submits his gift card design elements and finishes the process of creating the matching gift card, he may be provided with a barcode or other identifying element that can be sent to his mobile device or printed from his computer. This barcode or identifying element is the identifier for the unique gift card the user designed and can be used at the kiosk to identify this order and fulfillment of the order by generating a tangible gift card and outputting the gift card to the user.

### BRIEF DESCRIPTION OF THE DRAWINGS

FIG. 1 is a diagram depicting an exemplary kiosk in accordance with the instant disclosure.

FIG. 2 is a first portion of a flow diagram for a first exemplary process in accordance with the instant disclosure.

FIG. 3 is a second portion of a flow diagram for a first exemplary process in accordance with the instant disclosure.

FIG. 4 is a schematic diagram showing communication paths between kiosks and a central database/computer.

FIG. 5 is a first screen shot of an exemplary kiosk in accordance with the instant disclosure.

FIG. 6 is a second screen shot of an exemplary kiosk in accordance with the instant disclosure.

FIG. 7 is a third screen shot of an exemplary kiosk in accordance with the instant disclosure.

FIG. 8 is a fourth screen shot of an exemplary kiosk in accordance with the instant disclosure.

FIG. 9 is a fifth screen shot of an exemplary kiosk in accordance with the instant disclosure.

FIG. 10 is a sixth screen shot of an exemplary kiosk in accordance with the instant disclosure.

FIG. 11 is a schematic diagram showing communication paths between kiosks, users, a database, and a central system/computer.

FIG. 12 is a first portion of a flow diagram for a second exemplary process in accordance with the instant disclosure.

FIG. 13 is a second portion of a flow diagram for a second exemplary process in accordance with the instant disclosure.

FIG. 14 is a first portion of a flow diagram for a third exemplary process in accordance with the instant disclosure.

FIG. 15 is a second portion of a flow diagram for a third exemplary process in accordance with the instant disclosure.

FIG. 16 is a third portion of a flow diagram for a third exemplary process in accordance with the instant disclosure.

FIG. 17 is a first screen shot of an exemplary administrator program in accordance with the instant disclosure.

FIG. 18 is a second screen shot of an exemplary administrator program in accordance with the instant disclosure.

FIG. 19 is a third screen shot of an exemplary administrator program in accordance with the instant disclosure

FIG. 20 is a fourth screen shot of an exemplary administrator program in accordance with the instant disclosure

FIG. 21 is a fifth screen shot of an exemplary administrator program in accordance with the instant disclosure

### DETAILED DESCRIPTION

The exemplary embodiments of the present disclosure are described and illustrated below to encompass methods and devices whereby a user can create a matching personalized financial instrument to a greeting card or other retail product or service the user purchases or intends to purchase. Of course, it will be apparent to those of ordinary skill in the art that the embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure.

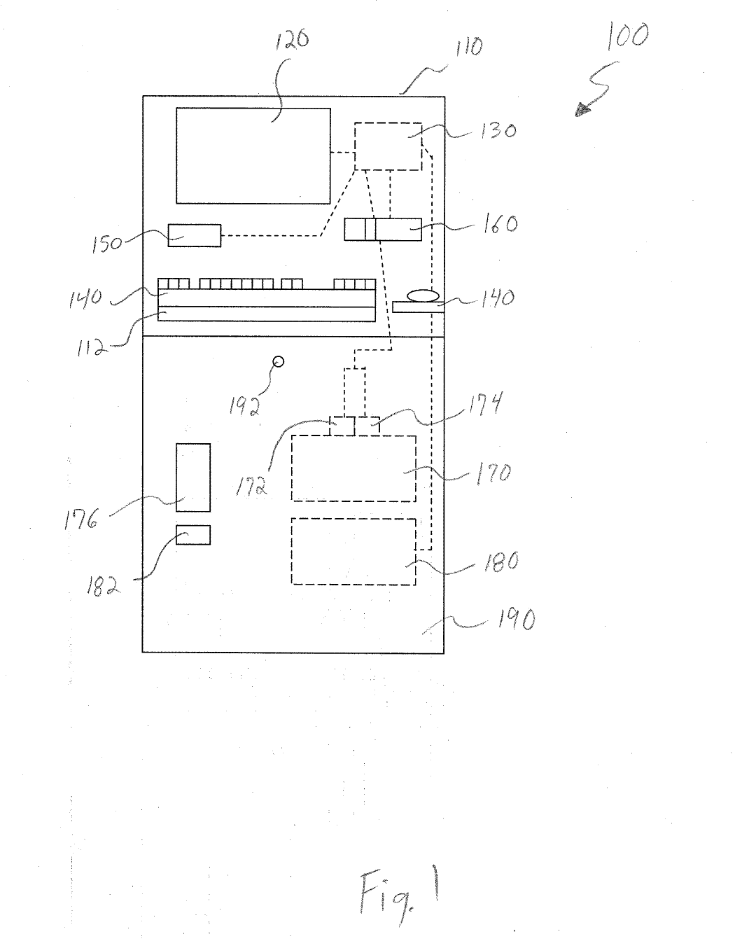

Referencing FIG. 1, an exemplary kiosk 100 in accordance with the instant disclosure includes a kiosk shell 110 housing a plurality of hardware components. More specifically, the kiosk shell 110 houses a portion of a visual display 120 that interfaces with a microprocessor 130 that may be incorporated as part of an on-board computer. By way of example, the visual display 120 comprises a 22-inch liquid crystal display that may optionally be touch sensitive. In instances where the visual display 120 is touch sensitive, the visual display may comprise a projected capacitive touch screen. In addition to being communicatively coupled to the visual display 120, the microprocessor 130 may be communicatively coupled to one or more peripheral input devices 140 such as, without limitation, a keyboard, a mouse, a trackball, a microphone, a hand-held scanner, a card reader, and a camera. The peripheral device(s) are used to generate inputs by way of the user to the microprocessor 130. The peripheral input device(s) 140 may be included regardless of whether the visual display 120 is touch sensitive. In this exemplary embodiment, the kiosk shell 110 includes a repositionable tray 112 upon which a keyboard and mouse 140 are mounted. This repositionable tray 112 allows ready access to the keyboard and mouse when certain inputs may be requested and, at the same time, allows the keyboard and mouse to be recessed at least partially within the kiosk shell 110 when not in use by a user.

The exemplary kiosk 100 may also include a scanner 150 that is mounted to the kiosk shell 110 and is communicatively coupled to the microprocessor 130. The scanner 150 may be used to scan codes such as, without limitation, one dimensional (1D) bar codes, two dimensional (2D) bar codes, and direct part marks. By way of example, the scanner 150 is operative scan an image on paper, etched into a product, or displayed on a mobile phone screen. As will be discussed in more detail hereafter, the scanner 150 provides inputs to the microprocessor 130 that are utilized to generate certain images on the visual display 120 in an interactive fashion.

A card reader 160 may also be mounted to the kiosk shell 110 and is communicatively coupled to the microprocessor 130. The card reader 160 may be used to read any number of cards such as, without limitation, ATM cards, bank cards (credit and debit cards including VISA and MasterCard), gift cards, loyalty cards, driver's licenses, telephone cards, membership cards, electronic benefit transfer cards (e.g. food stamps), and nearly any card in which value or secure information is not stored on the card itself. In addition, the card reader 160 may be designed to meet PCI DSS requirements to secure cardholder data, may be single or bi-directional swipe, and include encryption capabilities. By way of example, and as will be discussed in more detail hereafter, the card reader 160 is operative scan a credit card and provide an input to the microprocessor in order to authorize a transaction to occur at the kiosk 100

In addition to the foregoing input devices, the kiosk 100 may also include one or more output devices. For instance, the kiosk 100 may include a card printer 170 that is communicatively coupled to the microprocessor 130 and is housed completely within the kiosk shell 110. In this exemplary embodiment, the card printer 170 includes at least one of a universal serial bus port 172 and an Ethernet port 174 to allow communications to and from the microprocessor 130. In exemplary form, the card printer 170 carries out a dye sublimation thermal transfer process to print one or both sides of a card with high-quality, consistent, color or monochrome images. The card printer 170 also includes a cartridge that includes blank cards stored in a stack, where the blank cards are fed one at a time to the printing and encoding position within the card printer. To inhibit tampering with the card printer 170, the card cartridge may be locked and selectively unlocked by an authorized representative. In addition, the card printer 170 includes an encoder to encode a plurality of characters on a magnetic strip applied to one or both sides of the card. As will be discussed in more detail hereafter, these characters may include financial information for use in user purchases. In addition, the kiosk shell 110 includes a card slot 176 through which one or more gift cards are delivered to the kiosk user without providing complete access to the card printer 170 itself by the kiosk user.

The kiosk 100 may also include a printer 180 that is mounted to and housed within the kiosk shell 110 in order to provide the user of the kiosk with a paper receipt for one or more transactions carried out via the kiosk. In exemplary form, the printer 180 is communicatively coupled to the microprocessor 130 and includes a paper roll upon which information is printed indicative of a receipt. Moreover, the kiosk shell 110 includes a receipt slot 182 through which one or more receipts are delivered to the kiosk user without providing complete access to the printer 180 itself by the kiosk user. The printer 180 may include its own controller that monitors the amount of paper and conducts proactive diagnostics in order to instruct an authorized representative that the paper needs to be supplemented or that maintenance is needed.

The kiosk housing 110 includes a front door 190 that is repositionable with respect to the remainder of the kiosk housing. The front door 190 provides access to the internal components of the kiosk 100 such as the microprocessor 130, the card printer 170, and the printer 180. In order to retard tampering with the internal components of the kiosk 100, the front door 190 includes a lock 192 thereby allowing access to the internal components only by an authorized individual.

Additionally, as will be discussed in more detail herein, the microprocessor 130 may be in communication with one or more databases that may be on-board the kiosk 100 or located remote from the kiosk. Communication with a remote database by the microprocessor 130 may be via wired or wireless connection. In exemplary form, the microprocessor is communicatively coupled to the internet and includes a router for transmitting and receiving information over the internet.

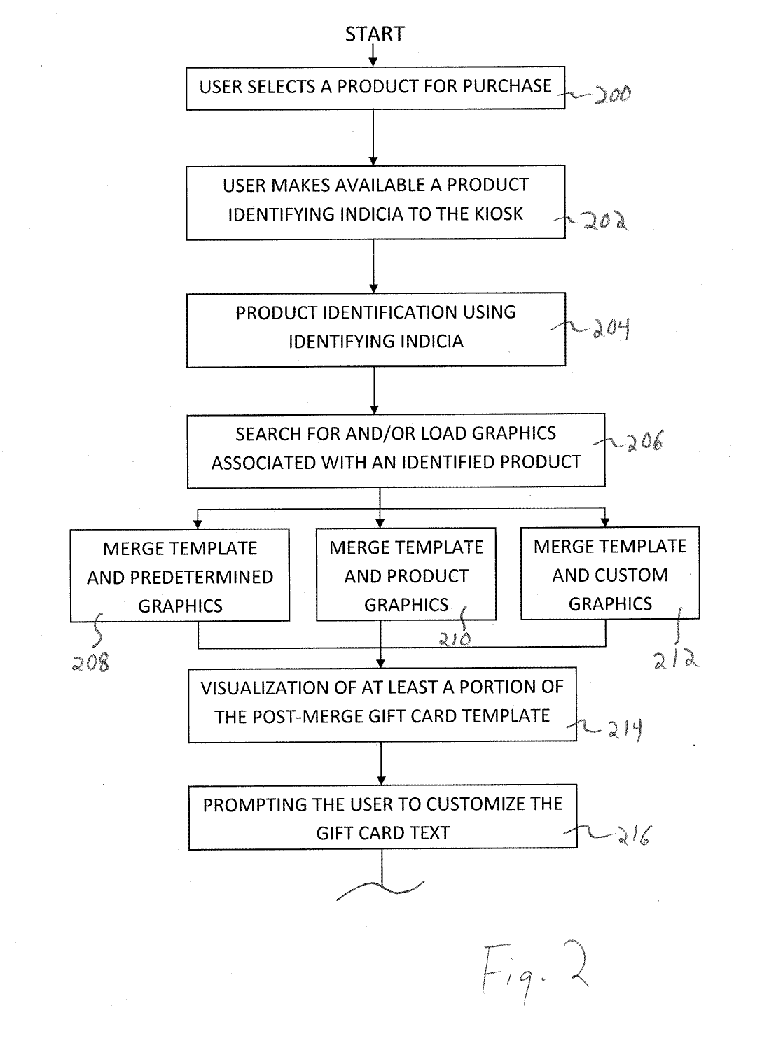

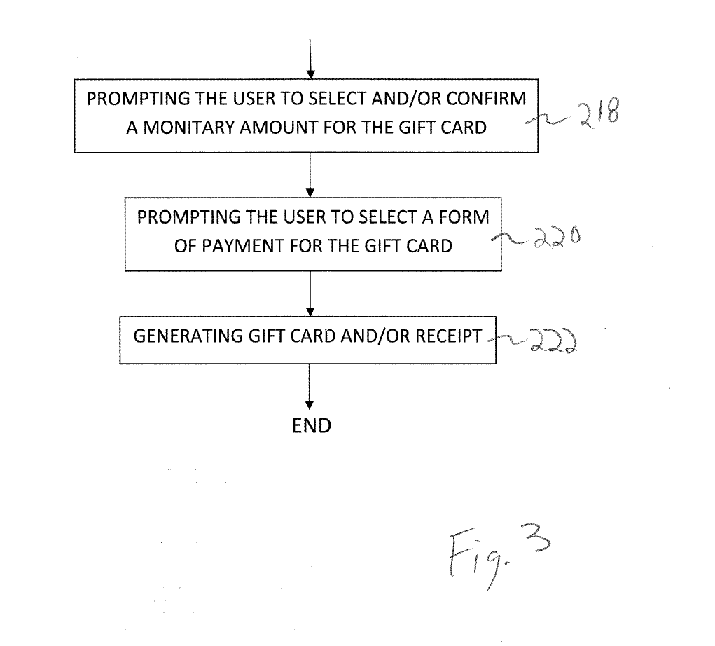

Referring to FIGS. 2-4, a first exemplary process will be described in which a user interacts with the foregoing kiosk 100 to generate a gift card that matches, is configured to have some relationship with, or is customized to correlate with a product or service a user intends to purchase. It should be understood, however, that a greeting card is only discussed as an example of one available product and those skilled in the art should comprehend that any other product or service may be substituted for or included in addition to the greeting card. Moreover, the gift card need not be accompanied by a second gift (such as a greeting card) as the gift card itself may be correlated to the product the gift card giver intended to purchase without ever having to purchase that item.

As an initial step 200, the user selects a product or service for purchase, in this case a greeting card. But, as explained in more detail hereafter, any other product or service may be used in lieu of or in addition to the greeting card and the process of generating the gift card according to this first exemplary process will not substantively change. For example, the user may select a television he intends to give as a gift where a gift card in an amount sufficient to cover the purchase price of the television is given in lieu of the actual television to avoid unnecessary product returns or differences in preference exhibited by the recipient of the gift. More specifically, for example, the gift recipient may desire a 42-inch LCD television instead of a 42-inch LED television. By giving a gift card in lieu of the actual television, the gift card giver allows the gift card recipient to purchase a different product than the one the gift card giver would have purchased without issues of product returns, standing in line, restocking fees, etc.

In a second step 202, the user makes available the bar code or product identifying indicia of the product (in this case a greeting card) to the kiosk 100 so that the kiosk can obtain information specific to the greeting card the user intends to purchase or has previously purchased. In exemplary form, the bar code or product identifying indicia may be scanned using the scanner 150. In the alternative or in addition, product identifying indicia may be entered using the peripheral input device(s) 140 or accessed through entering a session code corresponding to information saved from a prior session using the same kiosk, another kiosk, and/or an on-line resource such as a web server.

FIG. 5 shows an exemplary screen shot taken from the kiosk 100 visual display 120. As can be seen, the kiosk 100 visual display 120 prompts the kiosk user to scan a code (in this case a bar code) associated with a product (in this case a greeting card) the user intends to purchase.

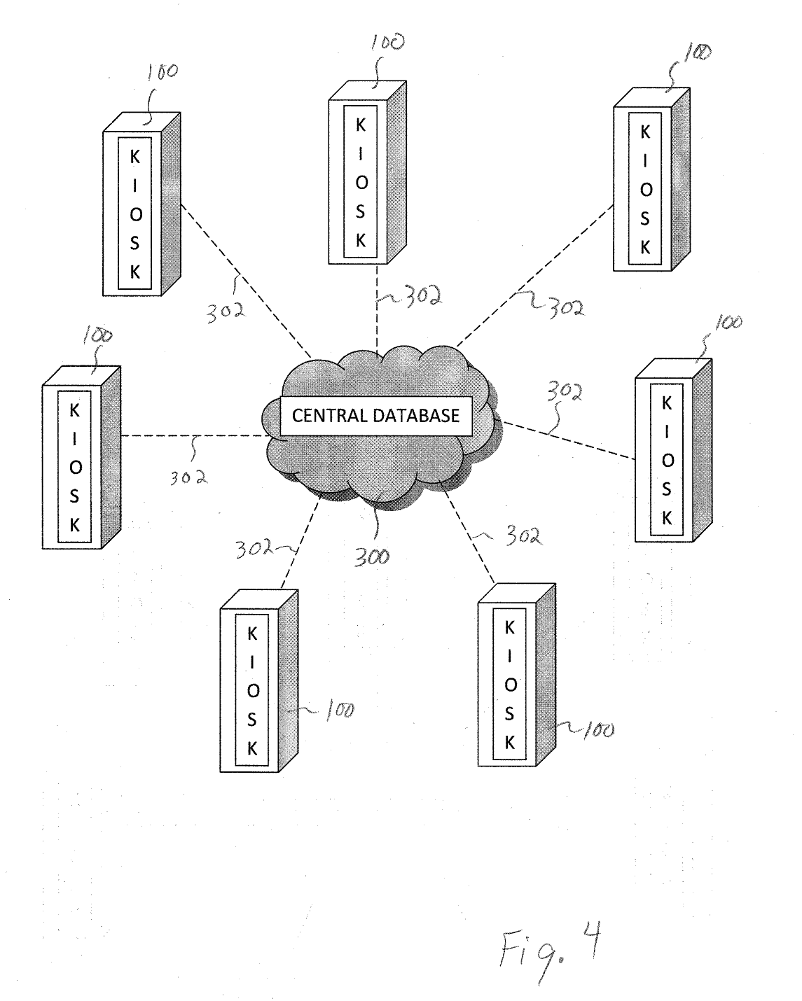

In step 204, the microprocessor 130 of the kiosk 100 uses the product identifying indicia or bar code to identify the product/service or a class of products/services (e.g., footwear, electronics, furniture, etc.). In exemplary form, the microprocessor 130 of the kiosk 100 may be communicatively coupled to one or more identification databases that may be part of a centralized database 300 of bar codes and product identifying indicia (see FIG. 4). This identification database may be local to the kiosk 100 (e.g., integrated into the hardware of the kiosk itself) or the database may be remote from the kiosk and accessible via a communication link 302 (i.e., wired or wireless). The microprocessor 130 accesses one or more identification databases and submits a search to match the bar code or other product identifier indicia to one or more pieces of information stored in the identification database to ascertain the product or class of products the user intends to purchase. It should be noted that it may not be necessary to access the identification database in cases where a greeting card (i.e., product or service in question) has a bar code or other readily ascertainable identification indicia that may be stored locally at the kiosk 100.

In step 206, after the product has been identified (in this case, a greeting card), the microprocessor 130 may access a correlation database that may be part of the central database 300. The correlation database includes a graphic or graphics assigned to product/service or classes of products/services. The microprocessor 130 may submit a search query to the correlation database for one or more graphics corresponding to the product (again, by way of example, a greeting card) the user has indicated he intends to purchase or has already purchased. In the alternative, the user may supply the product graphic, concurrent or subsequent to providing product identifying indicia, such as by making the product or its packaging available to a kiosk scanner or camera. In this circumstance, the graphic is directly loaded to the kiosk and one need not conduct a search for graphics that match the product the gift card giver intends to purchase.

In step 208, if corresponding graphics are located in the correlation database, the microprocessor retrieves this data from the database and merges this data into a gift card template. By way of example, the correlation database may be configured to generate graphics unique for a product in question. In other words, a single graphic or set of graphics may be stored in the correlation database for each specific greeting card a retailer stocks. For example, a typical greeting card includes one or more graphics that are distinguishable from one another. The most common examples of these graphics are the background color and the font used to print any text of the greeting card. In addition, the greeting card may include pictures, drawings, or other artwork that is unique to the greeting card. Consequently, it is highly unlikely that any two greeting cards will be identical or otherwise visually indistinguishable. As a result, the correlation database may include graphics that are product specific. By way of example, product specific graphics may include graphics that use the same color background and/or font as the greeting card. To the extent the greeting card includes other artwork (e.g., an animated character is on the greeting card), the graphics stored in the correlation database for that greeting card may include a miniature animated character to be printed on the eventual gift card. Those skilled in the art will understand that the correlation database includes at least one element tying together the eventual gift card with the greeting card so that when given together, it is clear that the gift card matches the greeting card. Nevertheless, it should be understood that the graphics stored for a particular greeting card may have two or more common ties, one or more of which may be incorporated visually into the eventual gift card.

In the alternative, in step 210, if the correlation database does not include preset graphics for the product in question, the microprocessor 130 may be configured to generate graphics unique for each product in question. In other words, the user may scan the greeting card at the kiosk and transmit this graphic information to the microprocessor 130. The graphic information may include one or more colors corresponding to the product (i.e., greeting card) the user intends to purchase, various styles of graphics present on the product, or characters present on the product. The processor 130 then extracts one or more graphic indicia from the product and merges this data into a gift card template.

In a further alternative, in step 212, the kiosk may present the user with various design tools and allow the user to create unique graphics that complement the greeting card the user purchased or intends to purchase. For example, if the greeting card includes red roses, the user may choose a gift card design that includes a single white rose to complement, yet provide a desired contrast to the greeting card. In this manner, the recipient of the greeting card and the gift card will immediately recognize the matching relationship between the gift card and the greeting card, though the graphics may not be identical or in common. Likewise, the kiosk user may deviate from any connection at all and custom design the graphics for the gift card using the design tools available. In exemplary form, the design tools include a palette of colors, a series of default graphics (characters, pictures, art work, etc.) to create the overarching design of the gift card. The processor then extracts the resulting graphic information chosen and merges this data into a gift card template.

In step 214, the microprocessor 130 generates instructions to the graphical user interface 120 to display a first portion of the gift card template to the user. By way of example, the first portion may include displaying the graphics retrieved from either step 206, 208, 210 or 212 on a visual representation of the eventual gift card. This visual representation allows the user to accept the graphics retrieved from step 206, 208, 210 or 212 or to go back to a previous step. Presuming the user is satisfied with the graphics merged into the gift card template, the user accepts the merged graphics and proceeds to step 216.

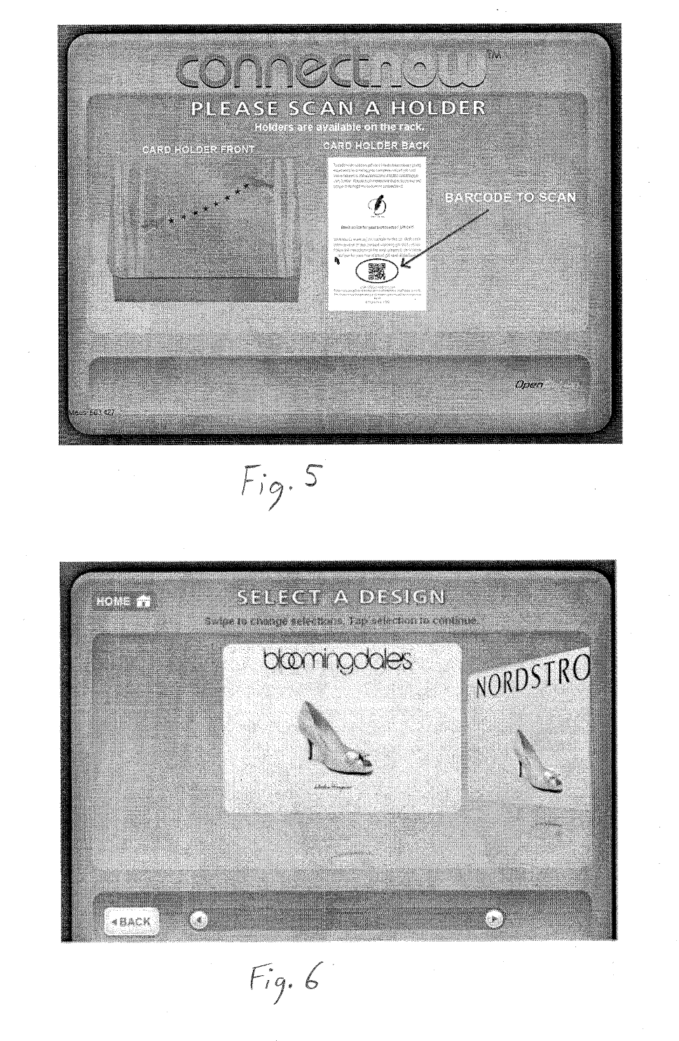

FIG. 6 shows an exemplary screen shot taken from the kiosk 100 visual display 120. As can be seen, the kiosk 100 visual display 120 prompts the kiosk user to accept the graphics retrieved from step 206, 208, 210 or 212 or to go back to a previous step. After the user is satisfied with the graphics merged into the gift card template, the user accepts the merged graphics and proceeds to step 216.

In step 216, the user is provided with one or more prompts via the graphical user interface 120 to customize the gift card. By way of example, the microprocessor 130 generates instructions to the graphical user interface 120 to display a first prompt to create text. By way of example, the user may be asked to select a font and font size for text that will be displayed on the gift card. The gift card template includes parameters that limit the text (to exclude profanity and other vulgar content) a user may put on the card, as well as the font size the user may choose. By way of example, presuming the microprocessor retrieved corresponding graphics from the correlation database in step 208, the gift card template may alert a user that the selected font is different from the font of the greeting card (i.e., the product the gift card giver intends to purchase). As a default, the gift card template may utilize the same font as is used on the greeting card. By way of example, the user may use the peripheral input device(s) 140 and/or the touch screen 120 to select the desired font and size. Similarly, the user may be provided with a series of default messages and/or given the opportunity to create a custom message for the gift card recipient. In exemplary form, the default messages may be made available to the kiosk user taking into account the greeting card the user intends to purchase. For example, if the user selects a birthday card, the default messages may include “Happy Birthday,” “Have a Wonderful Birthday,” “Wishing You an Amazing Birthday” or similar themed messages. In contrast, if the user selects a graduation congratulation card, the default messages may include “We are SO Proud of YOU,” “Congratulations,” “Welcome to the Workforce,” or similar themed messages. If the user prefers a customized message, the gift card, template allows the user to use the peripheral input device(s) 140 and/or the touch screen 120 to generate a custom message such as, “Amanda, you are the BEST!!!”.

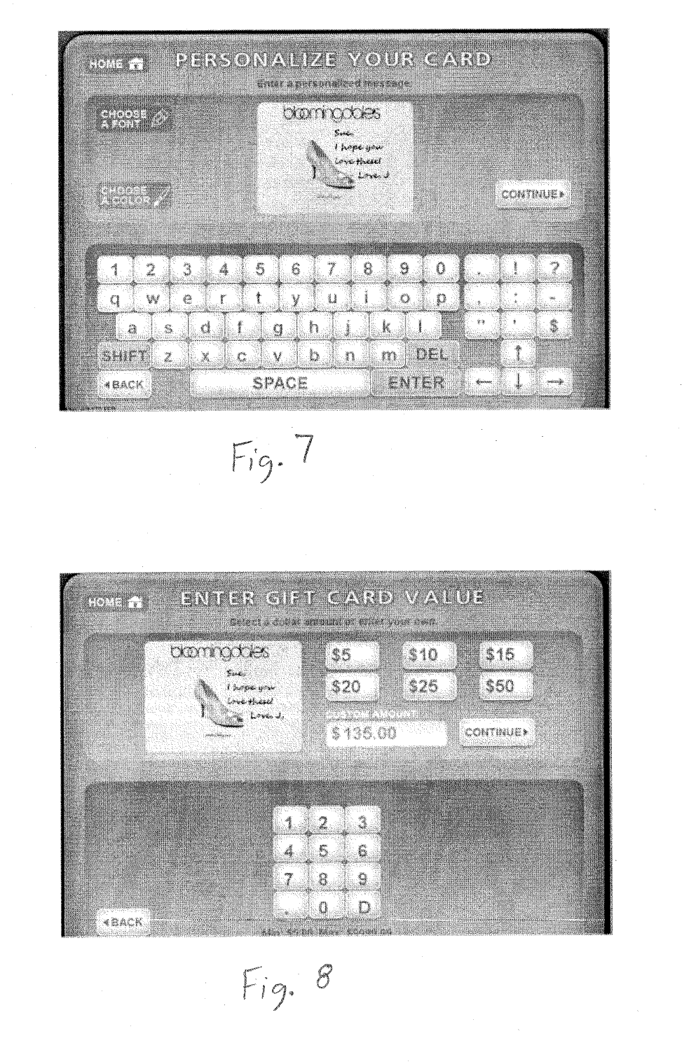

FIG. 7 shows an exemplary screen shot taken from the kiosk 100 visual display 120. As can be seen, the kiosk 100 visual display 120 prompts the kiosk user to personalize the gift card including changing the font, the color of the font, and the text associated with the gift card. After the user is satisfied with the customized graphics merged into the gift card template, the user accepts the merged graphics and proceeds to step 218.

In step 218, the user is prompted via the graphical user interface 120 to choose and/or confirm a monetary amount for the gift card. By way of example, the graphical user interface may display bills in incremental value (e.g., $5, $10, $20, $50, $100) and allow the user to choose the bill value. In addition or in lieu of predetermined amounts, the graphical user interface 120 may display a calculator that allows the user to input any amount within a predefined limit (e.g., $8.54). For example, the system 100 may not allow the user to put $100,000 on a gift card. And the system 100 may not allow the user to put less than one dollar on the gift card. The system 100 displays one or more error messages any time the user attempts to perform a step or make a decision that is outside of acceptable parameters. Presuming the selected amount is within acceptable parameters established by the system, the user proceeds to providing a form of payment.

In the alternative, the value of the gift card may be established by the price of the product the gift card giver intends to purchase. For example, the gift card giver intends to purchase a pair of running shoes, Nike AirMAX, but is unsure as to the gift card recipient's shoe size. The gift card giver, after using product indicia for the Nike AirMAX shoes so that the product can be identified, may be prompted by the kiosk 100 to confirm that the amount of the gift card coincides with the current price (optionally including any applicable tax too) of the Nike AIRMAX shoes just as if the gift card giver had purchased the shoes. In this manner, if the gift card recipient uses the gift card to purchase the Nike AIRMAX shoes, presuming no change in price of the shoes, the resulting balance on the gift card post purchase will be zero.

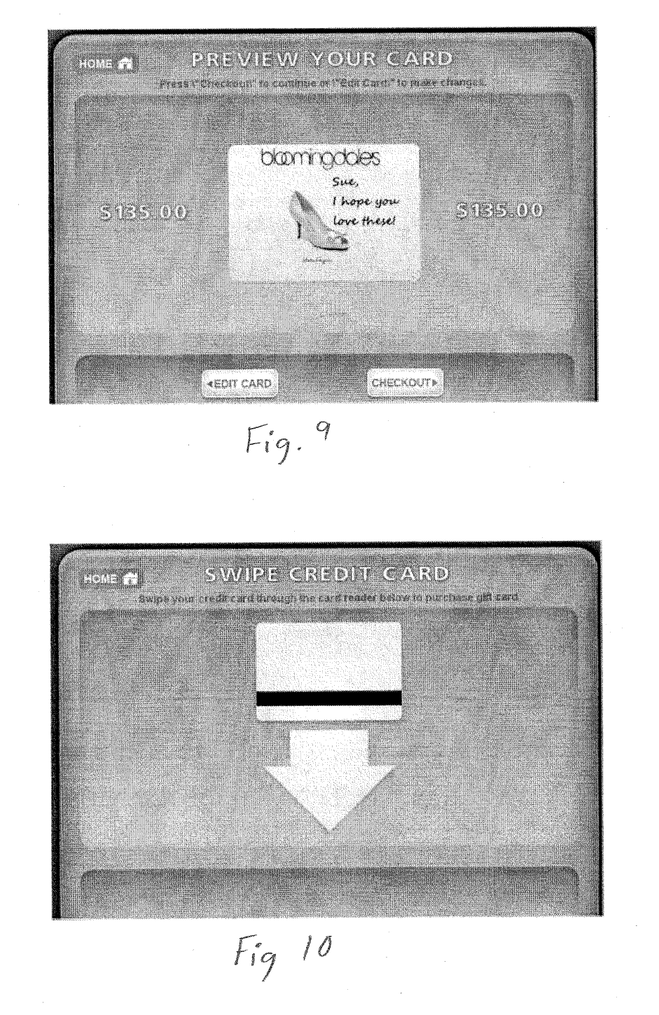

FIG. 8 shows an exemplary screen shot taken from the kiosk 100 visual display 120. As can be seen, the kiosk 100 visual display 120 prompts the kiosk user to enter the intended monetary value of the gift card. The kiosk displays predetermined dollar amounts and also includes a keypad for providing a specific monetary amount. FIG. 9 shows an exemplary screen shot taken from the kiosk 100 visual display 120. As can be seen, the kiosk 100 visual display 120 allows the user to preview the virtual gift card after or concurrent with selection of the monetary amount chosen for the gift card. After the user is satisfied with monetary amount, the process proceeds to step 218.

In step 220, the user is prompted to provide a form of payment. The graphical user interface 120 inquires about what form of payment the user desires to use, along with optionally providing icons that correspond to the available options. By way of example, the system 100 may accept credit card information, bank account information (e.g., savings, checking, etc.), cash, certified check, pre-authorized check or payment stub, or any other form of payment the system owner desires to accept. The user then selects the form of payment using the peripheral devices 140 or touchscreen 120 and then enters the requisite information as to the mode of payment. For example, the user may select “credit card” from the available payment options and then insert his credit card into the card reader 160. The card reader 160 is communicatively connected to a credit card network to process the transaction and receive confirmation that the credit card has not been terminated or is beyond its credit limit. Alternatively, the system 100 is communicatively coupled to any necessary banking or monetary network for which payment may be made in order to confirm the transaction is not facially fraudulent or otherwise prohibited. By way of example, this may include transactions involving bank savings or checking accounts. After receiving confirmation that the financial transaction has been approved and processed, the system 100 allows the process to proceed to the following stage.

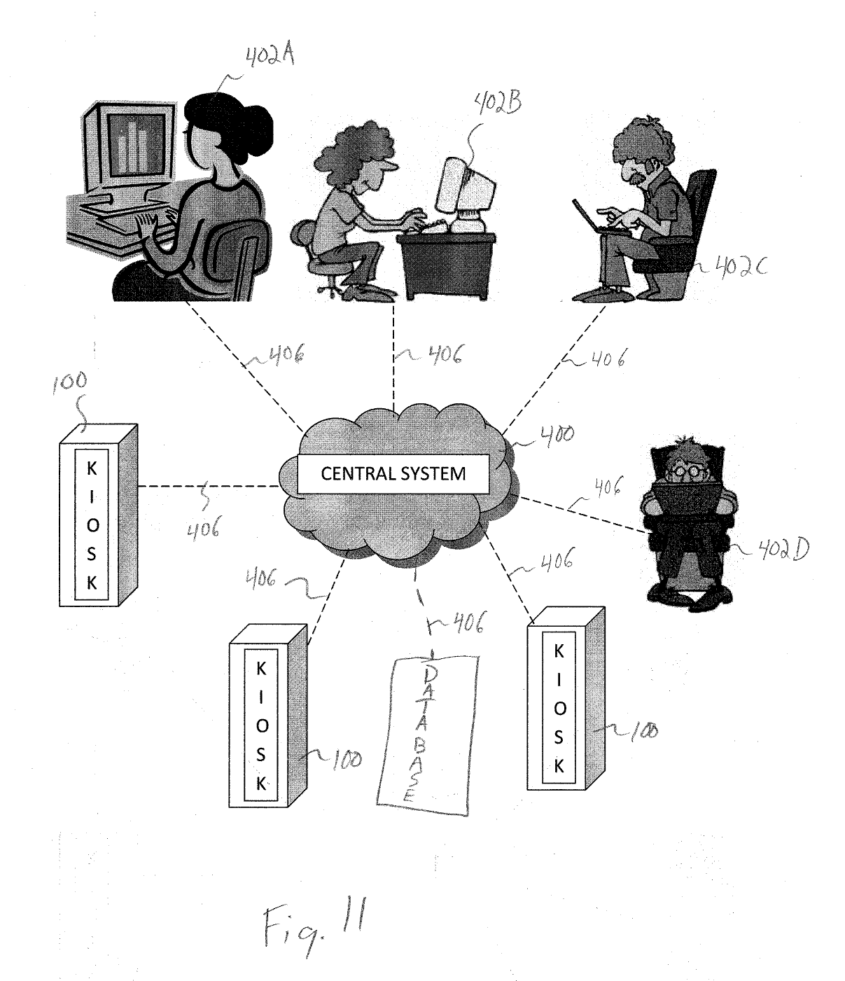

FIG. 10 shows an exemplary screen shot taken from the kiosk 100 visual display 120. As can be seen, the kiosk 100 visual display 120 prompts the kiosk user to enter a form of payment, in this case a credit card, by making use of a card reader associated with the kiosk.

At step 222, the system 100 prints one or more graphics (including any message) onto a tangible gift card blank. Again, the graphics match the product the gift card giver intends to purchase or has purchased. This may include graphics that correspond to a product that gift card giver actually purchases (e.g., a greeting card) or may correspond to a product the gift card giver intends to purchase but is hesitant to purchase because it may not be what the gift card recipient desires.

In exemplary form, a series of gift card blanks is stored in a magazine associated with the gift card printer 170. The gift card printer 170 monitors whether there is an available gift card blank in the magazine and will not allow a user to access the kiosk if a gift card blank is not within the magazine. Presuming a gift card blank is present, the printer not only provides the chosen graphics, but also imparts the requisite data onto the card (e.g., a magnetic strip) to allow the card to be used as a financial instrument. When the printer 170 is finished, the resulting gift card is output and made available to the kiosk user via the gift card slot 176.

At approximately the same time, the printer 180 generates a paper receipt and outputs this receipt to the kiosk user via the receipt slot 180. It should be understood, however, that the kiosk 100 need not provide the kiosk user with a paper receipt. Nevertheless, the printer 180 monitors the amount of paper available to generate a receipt and, if low on paper, alerts the owner or authorized representative of the owner to refill the paper.

When the user retrieves the printed gift card and the printed receipt, the process for generating the gift card is concluded. But the foregoing example is not the only way of generating a gift card (virtual or tangible) in accordance with the present disclosure.

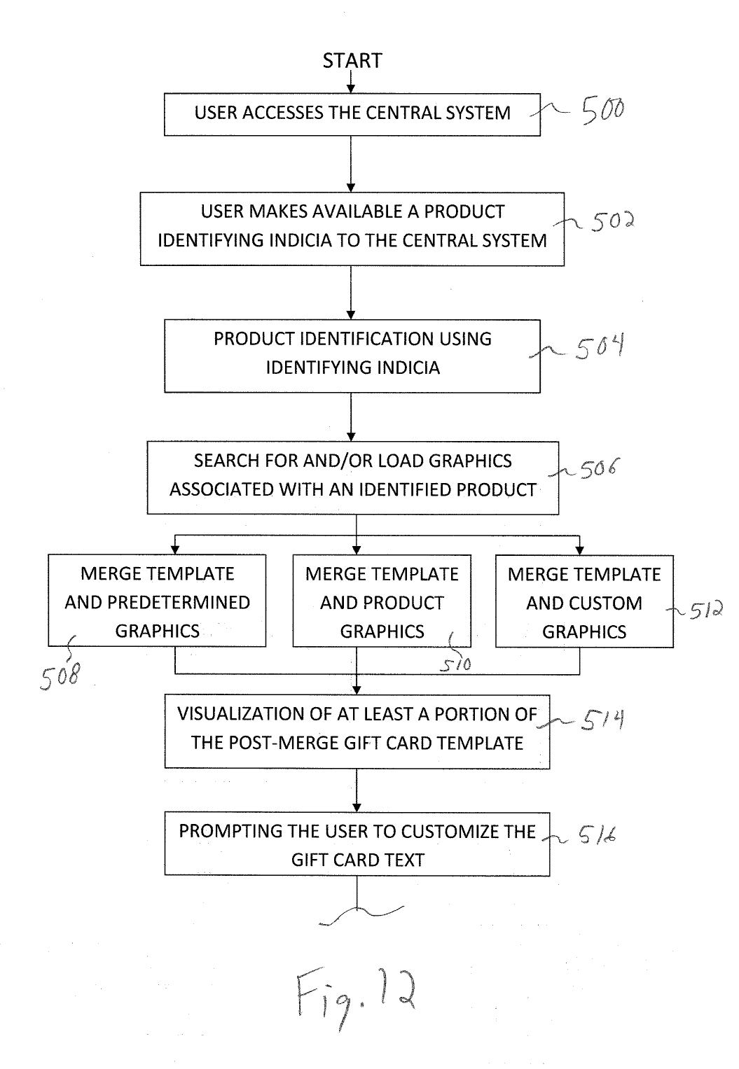

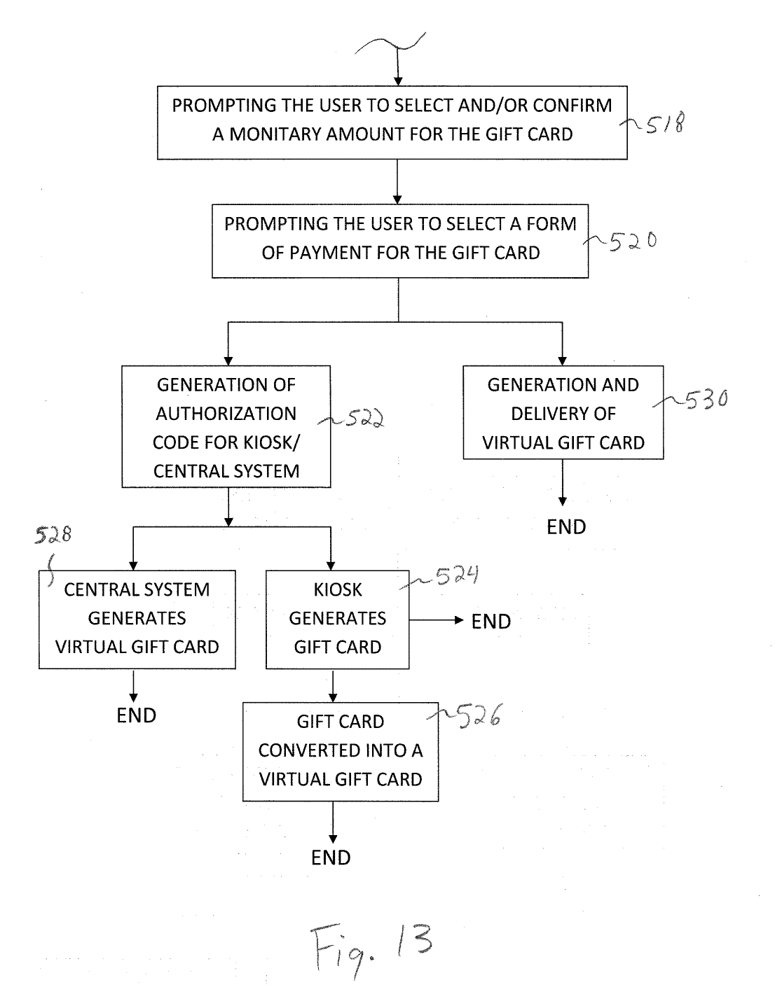

Referring to FIGS. 11-13, a second exemplary process for generating a gift card includes providing a central system 400 that communicates with one or more users 402A, 402B, 402C, 402D (users in the singular or plural will be referred to hereafter using reference numeral 402) to generate a virtual gift card. In this exemplary process, the user 402 may utilize this virtual gift card to generate a tangible gift card. Alternatively, the user 402 may use an electronic device to capture the virtual gift card and forward the virtual gift card to an intended recipient electronically without ever having generated a tangible gift card.

As an initial step 500, the user 402 accesses the central system 400. In exemplary form, the system 400 may comprise a server (e.g., a web server) that is accessible via a public or proprietary network (e.g., Internet). By way of example, the system 400 is accessible via the Internet by the user using his computer to establish a communication link therewith. The central system 400 may include a website and one or more webpages that are interfaced by the user in order to generate the virtual gift card. In this circumstance, it is presumed that the user has identified the product or service intended to be purchased at the time of accessing the central system 400. By way of example, this product may comprise a greeting card having a bar code or other identification indicia that is able to be transmitted to the central system 400.

In step 502, the user forwards the greeting card indicia to the central system 400 so that the central system can obtain available information concerning the greeting card. In exemplary form, the bar code or product identifying indicia may be scanned using a scanner local with respect to the user 402 or may be photographed using a camera. In the alternative or in addition, product identifying indicia may be entered using the peripheral input device(s) (keyboard, mouse, touchscreen, etc.) that are communicatively coupled to the user's local computer. In the alternative, the user may have started a session at a kiosk 100 and requested that the incomplete session be saved and available at a future time through the central system 400. In such a circumstance, the kiosk 100 will generate an identification code that will be made available to the user at the kiosk that may be entered at the user's computer (includes wireless devices such as tablet computers and smart phones, and public computers or computers of others) or at another kiosk simply by inputting the identification code to restart the incomplete session.

In step 504, the central system 400 uses the product identifying indicia (including any bar code) to identify the product/service or a class of products/services (e.g., footwear, electronics, furniture, carwashes, etc.). In exemplary form, the central system 400 is communicatively coupled to an identification database that may be part of a centralized database of bar codes and other product/service identifying indicia. This identification database may be local with respect to the central system 400 (e.g., integrated into the hardware of the server itself) and/or the database may be remote from the central system and accessible via a communication link 406 (i.e., wired or wireless). The central system 400 accesses the identification database and searches one or more pieces of information stored in the identification database to ascertain the product/service or class of products/services the user intends to purchase or has already purchased. It should be noted that it may not be necessary to access the identification database in cases where a greeting card the user intends to purchase or has purchased includes a bar code or other readily ascertainable identification indicia. Likewise, it may not be necessary to access the identification database in cases where the product/service the user intends to purchase or has purchased already includes graphics representative of the product/service in question.

In step 506, after the product has been identified, the central system 400 may access a correlation database, which itself may be part of the central system. The correlation database includes graphics assigned to product/service or classes of product/service. This correlation database is searched for graphics corresponding to the product the user intends to purchase or has already purchased. Alternatively, where the product has been identified by graphics already transmitted to the central system 400, there may be no need to search for graphics matching the product/service given that the identification graphics are also the correlation graphics.

In step 508, if corresponding graphics are located in the correlation database, the central system 400 retrieves this data from the database and merges this data into a gift card template. By way of example, the correlation database may be configured to generate graphics unique for a product/service in question. In other words, one or more graphics set may be stored in the correlation database for each specific product/service (e.g., a greeting card) a retailer stocks. For example, typical greeting cards include graphics that are distinguishable from one another. The most common examples of these graphics are the background color and the font used to print any text of the greeting card. In addition, the greeting card may include pictures, drawings, or other artwork that is unique to the greeting card. Consequently, it is highly unlikely that any two greeting cards (or products/services) will be identical. As a result, the correlation database may include unique graphics that are product specific. An example would include graphics that use the same color background as the greeting card. To the extent an animated character is on the greeting card, the graphics stored in the correlation database for that greeting card may include a miniature animated character to be printed on the eventual gift card. Those skilled in the art will understand that the correlation database includes at least one element tying together the eventual gift card with the greeting card the user intends to purchase. But the graphics stored for a particular greeting card may have two or more common ties.

In the alternative, in step 510, if the correlation database does not include preset graphics for the product in question, the central system 400 may utilize the graphics used to identify the product/service in question as set forth in step 506 to generate graphics unique for the product/service in question. In other words, the user may upload a scanned image of the product/service (e.g., a greeting card) to the central system 400. The graphic information may include one or more colors corresponding to the product/service (i.e., greeting card) the user intends to purchase or has purchased, various styles of graphics present on the product, or characters present on the product. The central system 400 then uses this graphic indicia from the product/service and merges this data into a gift card template.

In a further alternative, in step 512, the central system 400 may present the user with various design tools via the user's computer display and allow the user to create (using the user's peripheral devices) unique graphics that complement the product in question. For example, if the product is a greeting card includes the slogan, “Happy Birthday,” the user may choose a gift card design that includes clip art of a car with driver's keys to complement, yet provide a desired contrast to the greeting card. In this manner, the recipient of the greeting card and gift card will immediately recognize the relationship between the gift card and the greeting card, though the graphics are not identical or are not in common. Likewise, the user may deviate from any connection at all and custom design the graphics for the gift card using the design tools available via the Internet. In exemplary form, the design tools include a palette of colors, a series of default graphics (characters, pictures, art work, etc.) to create the overarching design of the gift card. The central system 400, based upon user inputs, then extracts the resulting graphic information chosen and merges this data into a gift card template.

In step 514, the central system 400 generates instructions (e.g., web pages) that are displayed on the user's graphical user interface to show a visual representation of the gift card template to the user. By way of example, the visual representation may include displaying the graphics retrieved from either step 506, 508, 510 or 512. This visual representation allows the user to accept the graphics resulting from step 506, 508, 510 or 512 or to go back to a previous step. In exemplary form, the user may be prompted to accept the graphics in order to maintain the merged graphics as part of the revised gift card template. But this prompting option is not required in order to proceed to step 516.

In step 516, the user is provided with one or more prompts via the user's graphical user interface to customize the gift card. By way of example, the central system 400 generates one or more webpages that are displayed on the user's graphical user interface that display a first prompt to create text associated with the gift card. By way of example, the user is asked to select a font and font size for text that will be displayed on the gift card. The gift card template includes parameters that limit the text a user may put on the card, to avoid profanity and other vulgar language, as well as the font size the user may choose. By way of example, presuming the central system 400 merged the gift card template with corresponding graphics from the correlation database in step 508, 510, or 512, the web page may alert a user that the selected font is different from the font of the greeting card the user purchased or desires to purchase. As a default, the web page displaying the results of the gift card template may utilize the same font as is used on the greeting card (i.e., the product the gift card giver has purchased or intends to purchase). By way of example, the user may use his computer's peripheral input devices and/or a touch screen to select the desired font and size. Similarly, the user may be provided with a series of default messages and/or given the opportunity to create a custom message for the gift card recipient. In exemplary form, the default messages may be made available to the user taking into account the product/service (in this case a greeting card) the user intends to purchase or has purchased. For example, if the user selects a birthday card as the product, the default messages may include “Happy Birthday,” “Have a Wonderful Birthday,” “Wishing You an Amazing Birthday” or similar themed messages. In contrast, if the user selects a graduation congratulation card, the default messages may include “We are SO Proud of YOU,” “Congratulations,” “Welcome to the Workforce,” or similar themed messages. If the user prefers a customized message, the template allows the user to use his peripheral input devices and/or a touch screen to generate a custom message such as, “Amanda, you are the BEST!!!”.

In step 518, the user is asked via the user's graphical user interface to choose and/or confirm a monetary amount for the gift card. By way of example, the web page may display bills in incremental value (e.g., $5, $10, $20, $50, $100) and allow the user to choose the bill value. In addition or in lieu of predetermined amounts, the web page may display a calculator that allows the user to input any amount within a predefined limit (e.g., $8.54). For example, the system 400 may not allow the user to put $100,000 on a gift card. And the system 400 may not allow the user to put less than one dollar on the gift card. The web page displays one or more error messages any time the user attempts to perform a step or make a decision that is outside of acceptable parameters. Presuming the selected amount is within acceptable parameters established by the system 400, the user proceeds to providing a form of payment.

In the alternative, the value of the gift card may be established by the price of the product the gift card giver intends to purchase. For example, the gift card giver intends to purchase a television, Sony Bravia LCD, but is unsure as to the gift card recipient's preferred screen size. The gift card giver, after using product indicia for the Sony Bravia LCD television so that the product can be identified, may be prompted by the webpage(s) to confirm that the amount of the gift card coincides with the current price (optionally including any applicable tax too) of the Sony Bravia LCD television the gift card giver intends to purchase just as if the gift card giver had purchased the television. In this manner, if the gift card recipient uses the gift card to purchase the Sony Bravia LCD television, presuming no change in price of the television, the resulting balance on the gift card post purchase will be zero.

In step 520, the user is prompted to provide a form of payment. One or more web pages of the central system 400 include questions about what form of payment the user desires to use, along with optionally providing icons that correspond to the available options. By way of example, the system 400 may accept credit card information, bank account information (e.g., savings, checking, etc.), paypal, or any other form of payment the system owner desires to accept. The user then selects the form of payment using his peripheral devices or touchscreen and then enters the requisite information as to the mode of payment. For example, the user may select “credit card” from the available payment options on the web page and then provide his credit card number and any security code to authorize payment via his credit card. The central system 400 is communicatively connected to a credit card network (not shown) to process the transaction and receive receipt that the credit card has not been terminated or is beyond its credit limit. Alternatively, the central system 400 is communicatively coupled to any necessary banking or monetary network (not shown) for which payment may be made in order to confirm the transaction is not fraudulent or otherwise prohibited (e.g., exceeds the monetary limits associated with the gift card giver). By way of example, this may include transactions involving bank savings or checking accounts. After receiving confirmation that the financial transaction has been approved and processed, the central system 400 allows the process to proceed to at least one of the following stages.

In step 522, the system 400 makes available to the user an authorization code that may be input to any participating kiosk 100 in order for the kiosk to print a tangible gift card. The authorization code is a one-time use code that may only be accessed once by a kiosk and thereafter the code is placed in an invalid state that is inoperative for any later kiosk to use the code to validate a gift card transaction. The central system 400 stores the authorization codes along with the requisite information the user has entered on-line so that when the kiosk communicates with the central system 400 and indicates a local user has entered a particular gift card authorization code, the central system checks to see if the code is active and, if so, it retrieves the corresponding data the kiosk needs to print the gift card. Consequently, presuming the authorization code is valid, in step 524, the kiosk 100 generates the tangible gift card as discussed in the prior exemplary process along with any receipt.

If the user inputs an authorization code that is inactive or invalid, the kiosk 100 will provide a message indicating the authorization code is either invalid or inactive. At this time, the kiosk 100 will direct the user to customer service to address any issues as to why the authorization code is not valid.

While the generation of a tangible gift card in step 524 may be the end of the process, the central system 400 may also utilize the tangible gift card to generate a virtual gift card. By way of example, presuming the gift card purchaser learns that the gift card recipient preferably purchases products/services on-line, the gift card giver may use the tangible gift card to convert this card into a virtual gift card.

In exemplary form, in step 526, the gift card giver (or the gift card recipient) may take the tangible gift card to a kiosk 100 or accesses the central system 400 via a communication network (e.g., the Internet), where the holder of the gift card is prompted to convert the card to a virtual card. By way of example, the gift card holder inserts the gift card into the card reader at the kiosk 100 or enters the code on the gift card using peripherals at the kiosk or at a computer communicatively coupled to the central system 400. If using the kiosk 100, the kiosk communicates with the central system 400 to confirm that the gift card is available for use (e.g., includes a positive balance and no stop payment or other notation has been recorded to inhibit use of the gift card). Upon confirming the gift card is available for use, the central system 400 may communicate the available balance on the gift card to the kiosk 100 or a linked computer the gift card holder is using, where the available balance is communicated to the user and the user is prompted to create a virtual card. It should be noted that the value of the virtual card need not be the same as the available balance on the gift card. Consequently, the card holder may create a virtual gift card that includes an available balance the same as, lesser, or greater than that of the tangible gift card prior to any transaction/conversion. Therefore, the card holder is prompted to indicate the value of the virtual card and this value is removed from the tangible card electronically via the central system 400 just prior to creation of the virtual gift card. Thereafter, the central system 400 electronically communicates to the user a virtual gift card when the on-line process is complete. In exemplary form, this virtual gift card may be downloaded from the central system 400 and stored on the user's computer or mobile device, or emailed or otherwise communicated to the user. In the alternative, the central system 400 may electronically transmit or make available the virtual gift card to another party designated by the user.

In exemplary form, the virtual gift card is an electronic version of a tangible gift card and includes the graphical information that would be present on the tangible gift card, except the information is provided in a visual electronic file. This virtual gift card also includes the embedded information necessary to use the virtual gift card as a financial instrument.

Referring back to step 522, the user may alternatively decide to use the authorization code to create a virtual gift card (via the kiosk 100 or central system 400). This step may be included to account for instances where the gift card giver has the authorization code, but has not yet used the code to create a tangible gift card. This step 528 may be utilized when the gift card giver learns that the gift card recipient would prefer a virtual gift card. Whether accessing the central system 400 via the user's computer or via a kiosk 100, the user directs communications to the central system 400 requesting generation of a virtual gift card by inputting the authorization code generated in step 522. The central system 400 then verifies that the authorization code is valid and generates the virtual gift card.

Referring back to step 520, the user may alternatively decide to create a virtual gift card (via the kiosk 100 or central system 400) without receiving an authorization code. At alternative step 530, the user indicates to the central system 400 using the user's computer or kiosk 100 that a virtual gift card is desired. Having already in its possession the information to verify that the virtual gift card may be created, the central system 400 creates the virtual gift card and communicates this virtual card to the user or user's designated recipient. This communication may occur directly at the kiosk 100 via a Bluetooth connection or other pairing between the kiosk and a wired or wireless device of the user or user's recipient. Alternatively, the kiosk 100 or central system 400 may email or otherwise electronically deliver the virtual gift card. As discussed previously, the virtual gift card includes the visual attributes of the tangible gift card and also includes the financial attributes to allow the virtual gift card to be utilized for payment of products/services.

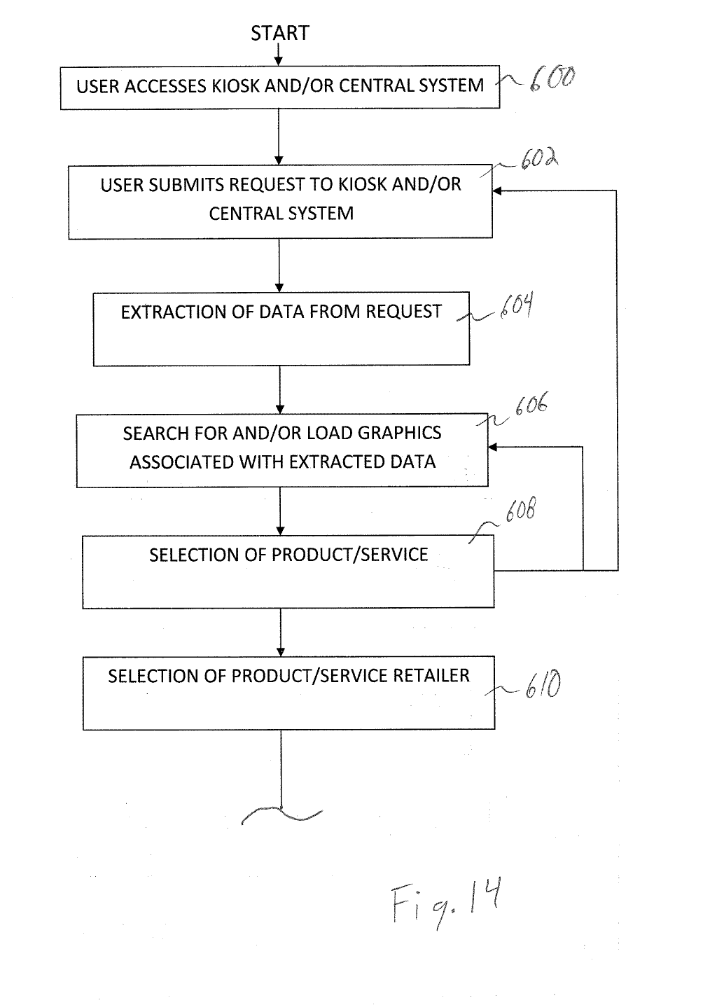

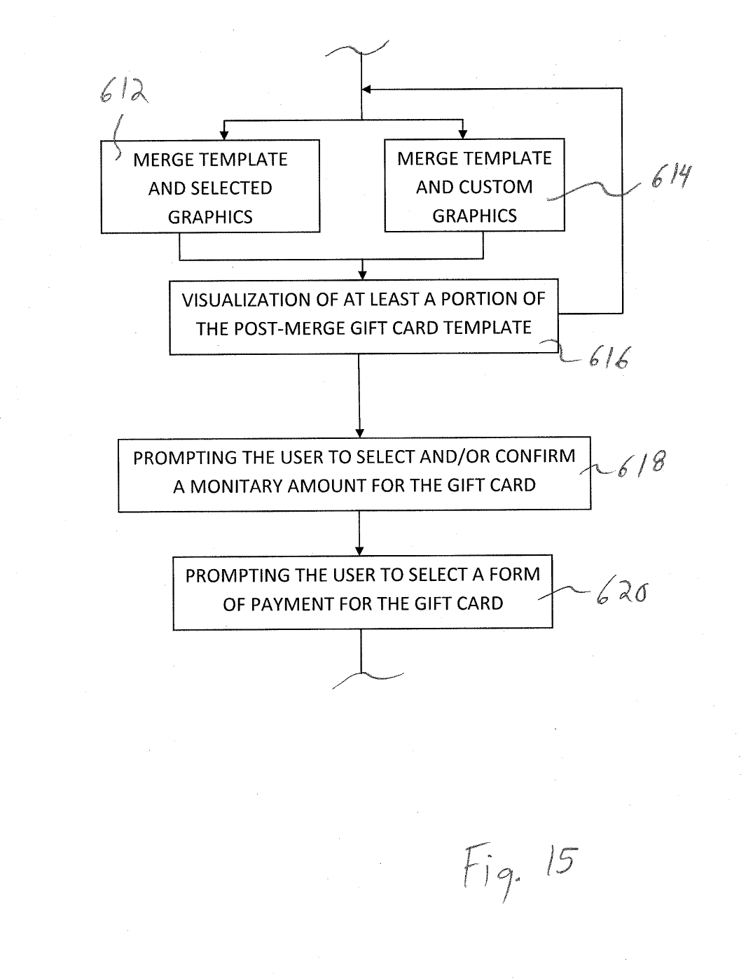

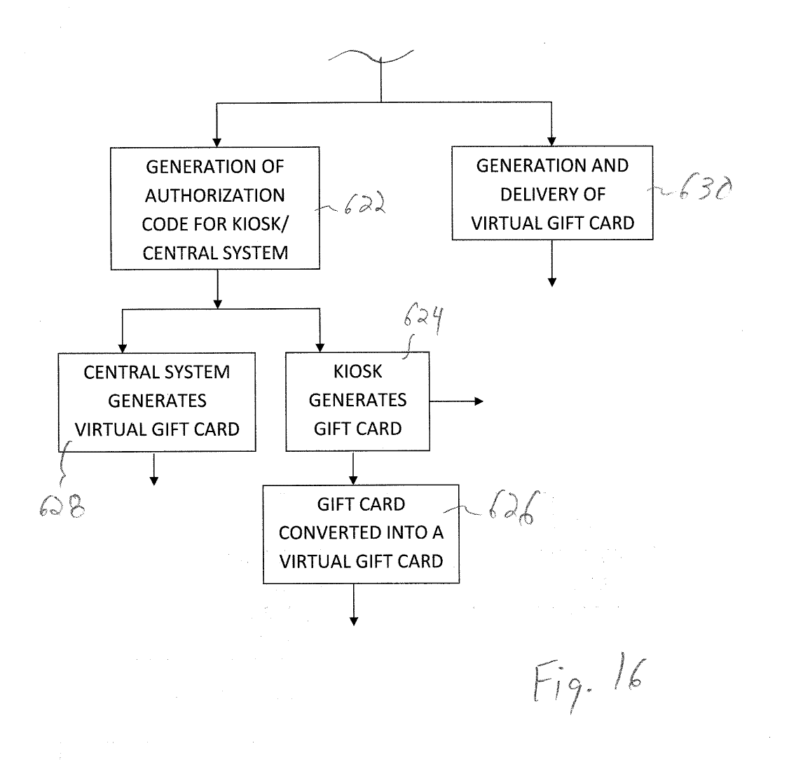

Referencing FIGS. 14-16, an alternate exemplary embodiment a gift card consumer may interact with a kiosk and/or a central system computer to generate at least one of virtual gift card and a tangible gift card. In exemplary form, this alternate embodiment includes a process, associated hardware, and associated software for generation of gift cards that match a product/service the gift card giver intends to purchase. As an initial step 600, the gift card giver (i.e., a “user”) accesses a kiosk and/or a central system computer directly. In this exemplary embodiment, one or more kiosks are communicatively coupled to the central system computer. Though not necessary, each kiosk may include the same hardware as described previously for the kiosk 100 of FIG. 1. Each kiosk includes a processor running a software program that facilitates communication with the central system computer or another networked computer. This same or similar program may be accessed by the user via the Internet (set forth on one or more web pages) or another network from the user's computer or a computer being used by the user. Nevertheless, whether the process takes place via the kiosk or a user computer, the exemplary process is essentially the same.

The software program asks the user what the user is looking for. In exemplary form, the user may be looking for a product or service, such as a SpongeBob SquarePants (SpongeBob“) toy, but is uncertain as to precisely what particular product or service should be purchased and/or the retailer that may sell the product or service. Consequently, the exemplary embodiment provides options to the user not only about the gift card itself, but about the retailer where the product/service in question is available.

In step 602, the user enters his answer to the “what are you looking for” question, in this example the user indicates he is looking for a SpongeBob toy. This answer may be typewritten using a keyboard, virtual keyboard, or may be given using camera and/or a microphone. In exemplary form, the kiosk includes a keyboard, a virtual keyboard option, a camera, and/or microphone teamed with voice recognition software. Thus, the user may speak, type, or visually show to the kiosk the answer to what he user is looking for. In the context of the central system computer accessed via a remote computer used by the user, the same question is asked concerning what the user is looking for by way of an email or web page query. The consumer may use one or more of the attributes available to the user locally to submit to the central system computer the answer to this threshold question including, without limitation, a keyboard, a mouse, a virtual keyboard on a touchscreen, a microphone, a camera, and saved graphics (e.g., images).

At step 604, the central system computer directly, or using the kiosk as a conduit, extracts the relevant information entered by the user using well known data extraction algorithms.

At step 606, this extracted information is utilized by the central system computer to search for product/service images that correspond to available products/services corresponding to the answer given by the user as to what he is looking for. By way of example, the central system computer may be Internet accessible and use its own search engine or a publicly available search engine (e.g., Google, Bing, etc.) to search for and locate images that are responsive to the user's inquiry. In this example, the central system computer displays one or more images corresponding to products/services that are responsive to the user's answer. This display, in the context of the kiosk is on a display associated with the kiosk, while in the context of a user computer is on a display associated with the user computer. Specifically, for example, in the context of a SpongeBob search, the central system computer would cause to be displayed a series of different products that each relate to SpongeBob.

At step 608, the user reviews he graphical results and decides whether one or more of the product/service images is what the gift card giver intends or intended to purchase. In the context of the kiosk, the product/service images are operable as icons on the display to initiate further process steps once selected. Similarly, when displayed on the user's computer, the graphical images provide icon functionality and allow the user to select one or more of the images.

Upon reviewing the graphical search results, the user may determine that the search results provided are not extensive enough and request the central system computer (optionally via the kiosk) to return to step 606 and conduct a more extensive search and display additional search results. And this process may be repeated as necessary until the user stops the process or is content with his product/service selection(s).

In addition, upon reviewing the graphical search results, the user may determine that the search results are not appropriately responsive to his answer as to what he was looking for in step 602 and decides to return to step 602 to re-enter his answer. For example, the initial answer in step 602 may have been, “I'm looking for SpongeBob.” But this general answer may result in the user receiving images relating to T-shirts, coffee mugs, and other products that are not suited for a child, which is the intended recipient of the gift card. Consequently, the user may decide to refine his answer and go back to step 602 by stating, “I'm looking for SpongeBob child chair.” Accordingly, the process would then proceed to step 604 using this revised answer and provide one or more images of products that correspond to a SpongeBob child chair at step 606. Again, the user may select one or more of these displayed images that correspond to a product the user intends or intended to purchase.

After the product(s)/service(s) have been selected by the user in step 608, the central system computer proceeds to step 610 and provides information to the user (via the kiosk or the user's computer) regarding retailers that may offer a product corresponding to the image(s) selected by the user in step 608. By way of example, the user selected a particular image of a SpongeBob child chair. The central system computer thereafter searches for retailers that offer a product corresponding to the image selected by the user. Likewise, the central system computer may inquire with the user as to the gift card recipient's resident address. Using information as to the retailer(s) offering a product corresponding to the image(s) the user selected and any address information input concerning the gift card recipient, the central system computer makes suggestions to the user as to the store where the gift card may be redeemed and the location of suggested retailers with respect to the residence of the gift card recipient.

By way of example, the user selected an image of a SpongeBob child chair and provided information that the intended gift card recipient (a child) lives in Mason, Ohio. The central system computer conducts a search for retailers in or near Mason, Ohio that sell the SpongeBob child chair the user selected. As part of this search, the central system computer may confine the search to a particular geographic area using the address information provided by the user. More specifically, the search may be confined to predetermined limits (e.g., the number of stores selling the product/service, the distance from the intended gift card recipient's residence, the number of stores affiliated with the same chain). By way of example only, the search is limited to ten stores that sell the product/service in question, with no particular geographic range limitation (such as within 50 miles of the residence address only), and is limited to no more than two stores within the same chain (i.e., no more than two Wal-Mart stores would be listed despite the fact that a third Wal-Mart store is closer to the intended gift card recipient's address than is another store in the search results). The search results (name of retailer and proximity to intended gift card resident) are made available to the user. In addition, the search results may include the advertised retail price for the product/service in question. In this example, the search results identified ten stores in or near Mason, Ohio that sell the SpongeBob child chair in question. The user is then prompted to optionally select one of these retailers for redemption of the gift card. The user, by way of example, may note that a Wal-Mart is within two miles of the intended gift card recipient and decide to have the gift card be a Wal-Mart gift card. It should be understood, however, that the eventual gift card need not be tied to a particular retailer but may be analogous to a debit or credit card that may be redeemed at any product/service retailer having the appropriate redemption capabilities. Moreover, if the price of the product/service in question is available, the central computer may retain this price information for when the user is asked to set the monetary value of the gift card.

Subsequent to step 610, the process proceeds to step 612 or step 614 to merge graphics with a gift card template. By way of example, in step 612, graphics that have been searched, produced to the user, and selected are saved and available to be merged into a virtual gift card template. Presuming the user has selected only one product/service, the graphic depicted in step 608 is available to be merged into the template. In addition or in the alternative, the user has the option to resize the graphics and use multiple graphics on a single card. In this example, the graphics merged into the gift card template include an image of a SpongeBob child chair that will be printed on the gift card. In a circumstance where multiple products/services have been selected, the user is presented with the option to include one or more of these graphics. An example would be if the user had selected the SpongeBob child chair and a child basketball hoop. In such a circumstance, the user is asked whether one or both of the SpongeBob graphics and the basketball hoop graphics are to appear on the gift card.

Presuming the user has chosen to have the gift card be affiliated with a retail store, retail store graphics will also be merged into the gift card at step 612. For example, as discussed above, if the user chooses to have the gift card be associated with Wal-Mart, Wal-Mart graphics will be merged into the gift card template to provide visual information that the card is a gift card to Wal-Mart. It should be understood, however, that certain retail stores and service providers may be brother and sister stores under common ownership, control, or partnering together. In such an instance, a plurality of graphics may be merged into the gift card template to ensure a visual indication that the gift card is eligible to be redeemed at multiple stores having different names and offering different products/services.

By way of example, in step 614, graphics that have been searched, produced to the user, and selected are saved and available may be merged into a virtual gift card template. Presuming the user has selected only one product/service, the graphic depicted in step 608 is available to be merged into the template. In addition or in the alternative, the user has the option to resize the graphics and use multiple graphics on a single card. In this example, the graphics merged into the gift card template include an image of a SpongeBob child chair that will be printed on the gift card. In a circumstance where multiple products/services have been selected, the user is presented with the option to include one or more of these graphics. An example would be if the user had selected the SpongeBob child chair and a child basketball hoop. In such a circumstance, the user is asked whether one or both of the SpongeBob graphics and the basketball hoop graphics are to appear on the gift card. But step 614 also provides the opportunity to have custom graphics also associated with a gift card template.

The central system computer generates one or more webpages or kiosk prompts to allow the creation of additional images and text that will be associated with the gift card by merger with the gift card template. By way of example, the user is asked to select a font and font size for text that will be displayed on the gift card. The gift card template includes parameters that limit the text a user may put on the card, to avoid profanity and other vulgar language, as well as the font size the user may choose. By way of example, presuming the central system computer merged the gift card template with corresponding graphics selected in step 608, the web page or kiosk display may alert a user that the selected font size is too small or too large. As a default, the web page or kiosk screen displaying the results of the gift card template may utilize a predetermined font and font size. By way of example, the user may use his computer's peripheral input devices and/or a touch screen to select the desired font and size. Similarly, the user may be provided with a series of default messages and/or given the opportunity to create a custom message for the gift card recipient. In exemplary form, the default messages may be made available to the user taking into account the product/service (in this case, for example, a SpongeBob child chair and a basketball hoop) the user intends to purchase. For example, depending upon the product/service, the preloaded messages may include “SpongeBob Thought You Might Like This,” “Hoop It Up,” “Shoot to Win” “Take a Seat on SpongeBob” or similar themed messages. If the user prefers a customized message, the template allows the user to use peripheral input devices and/or a touch screen (whether via the user's computer or kiosk) to generate a custom message such as, “Happy Birthday David”.

Presuming the user has chosen to have the gift card be affiliated with a retail store, retail store graphics will also be merged into the gift card at step 614. For example, as discussed above, if the user chooses to have the gift card be associated with Wal-Mart, Wal-Mart graphics will be merged into the gift card template to provide visual information that the card is a gift card to Wal-Mart. It should be understood, however, that certain retail stores and service providers may be brother and sister stores under common ownership, control, or partnering together. In such an instance, a plurality of graphics may be merged into the gift card template to ensure a visual indication that the gift card is eligible to be redeemed at multiple stores having different names and offering different products/services.

Regardless of which merger step 612, 614 is utilized, the process proceeds post merger to step 616 where the user is able to view a graphical depiction of the virtual gift card. In particular, the graphical depiction includes images of at least one of the front and the back of the virtual gift card. Those skilled in the art will understand that an electronic gift card need not include two graphical sides, but in this exemplary embodiment the virtual card is formatted to include two sides in order to be able to print graphics on both sides of a tangible gift card. By way of example, the first side of the virtual card may include one or more graphics associated with the product(s)/service(s) the user has intended to purchase. And the second side of the virtual card may include one or more graphics indicating the retail locations where the gift card may be redeemed. Alternatively, if no retail store is selected for redemption by the user in step 610, the second side may also include graphics relating to the product(s)/service(s) intended to be purchased or customized graphics.

If the user us dissatisfied with the appearance of the virtual gift card, the user may navigate back to either step 612 or 614 to change one or more graphics associated with the card. After making any changes, the modifications are merged into the virtual gift card template and the revised template is viewable in step 616.

It should also be noted that the virtual gift card template may include a preview of the graphical areas so that the user can view the graphics before the merger acts 612, 614 are completed to avoid having to go back to a prior step if the appearance of the virtual gift card is not satisfactory. Consequently, the visualization step 616 may be incorporated into either or both steps 612, 614.

After the virtual gift card template has proceeded past step 616, the user is prompted to choose and/or confirm a monetary amount for the gift card. By way of example, the web page or kiosk may display bills in incremental value (e.g., $5, $10, $20, $50, $100) and allow the user to choose the bill value. In addition or in lieu of predetermined amounts, the web page or kiosk may display a calculator that allows the user to input any amount (e.g., $8.54) within a predefined limit. For example, the central system computer may prohibit the user from putting more than $100,000 on a gift card. And the central system computer may not allow the user to put less than one dollar on the gift card. The web page or kiosk displays one or more error messages any time the user attempts to perform a step or make a decision that is outside of acceptable parameters. Presuming the selected amount is within acceptable parameters established by the system central system computer, the user proceeds to providing a form of payment.

In the alternative, the value of the gift card may be established by the price of the product(s)/service(s) the gift card giver intends to purchase. For example, the gift card giver intends to purchase the SpongeBob child chair and a basketball hoop, but is unsure as to the actual size of the chair and basketball hoop. The gift card giver, after selecting graphics used to identify the product(s)/service(s) intended to be given as part of the gift card, may be prompted by the webpage(s) or kiosk to confirm that the amount of the gift card coincides with the current price (optionally including any applicable tax too) of the chair and basketball hoop. In this manner, if the gift card recipient uses the gift card to purchase the chair and basketball hoop, presuming no change in price of either item, the resulting balance on the gift card post purchase will be zero.

In step 620, the user is prompted to provide a form of payment. One or more web pages or screens of the kiosk include questions about what form of payment the user desires to use, along with optionally providing icons that correspond to the available options. By way of example, the central system computer may accept credit card information, bank account information (e.g., savings, checking, etc.), paypal, or any other form of payment the system owner desires to accept. The user then selects the form of payment using his peripheral devices or touchscreen (residing at a local computer) or uses the peripherals and/or touchscreen associated with the kiosk and then enters the requisite information as to the mode of payment. For example, the user may select “credit card” from the available payment options on the web page and then provide his credit card number and any security code to authorize payment via his credit card. The central system computer is communicatively connected to a credit card network (not shown) to process the transaction and receive receipt that the credit card has not been terminated or is beyond its credit limit. Alternatively, the central system computer is communicatively coupled to any necessary banking or monetary network (not shown) for which payment may be made in order to confirm the transaction is not fraudulent or otherwise prohibited (e.g., exceeds the monetary limits associated with the gift card giver). By way of example, this may include transactions involving bank savings or checking accounts. After receiving confirmation that the financial transaction has been approved and processed, the central system computer allows the process to proceed to at least one of the following stages.

In step 622, the central system computer makes available to the user or kiosk an authorization code necessary for a participating kiosk to print a tangible gift card. The authorization code is a one-time use code that may only be accessed once by a kiosk and thereafter the code is placed in an invalid state that is inoperative for any later kiosk to use the code to validate a gift card transaction. The central system computer stores the authorization codes along with the requisite information the user has entered so that when the kiosk communicates with the central system computer to verify that the authorization code is active. If the entire process has been conducted at the same kiosk at one time, then the kiosk receives a confirmation from the central system computer and proceeds to print the tangible gift card. Alternatively, if the entire process has not been conducted at the same kiosk at one time, the relevant kiosk post step 620 communicates with the central system computer to verify the authorization and verify/receive the corresponding graphic and financial data the kiosk needs to print the gift card. Consequently, presuming the authorization code is valid, in step 624, the kiosk generates the tangible gift card representative of the virtual gift card.

If the user inputs an authorization code that is inactive or invalid, the kiosk will provide a message indicating the authorization code is either invalid or inactive. At this time, the kiosk will direct the user to customer service to address any issues as to why the authorization code is not valid.

While the generation of a tangible gift card in step 624 may be the end of the process, the central system computer may also utilize the tangible gift card to generate a virtual gift card. By way of example, presuming the gift card purchaser learns that the gift card recipient preferably purchases products/services on-line or otherwise has more use for a virtual gift card than a tangible gift card, the gift card giver may use the tangible gift card to convert this card into a virtual gift card.

In exemplary form, in step 626, the gift card giver (or the gift card recipient) may take the tangible gift card to a kiosk or accesses the central system computer via a communication network (e.g., the Internet), where the holder of the gift card is prompted to convert the tangible gift card to a virtual gift card. By way of example, the gift card holder inserts the gift card into the card reader at the kiosk or enters the code on the gift card using peripherals at the kiosk or at a computer communicatively coupled to the central system computer. If using the kiosk, the kiosk communicates with the central system computer to confirm that the gift card is available for use (e.g., includes a positive balance and no stop payment or other notation has been recorded to inhibit use of the gift card). Upon confirming the gift card is available for use, the central system computer may communicate the available balance on the gift card to the kiosk or a linked computer the gift card holder is using, where the available balance is communicated to the user and the user is prompted to create a virtual card. It should be noted that the value of the virtual card need not be the same as the available balance on the gift card. Consequently, the card holder may create a virtual gift card that includes an available balance the same as, lesser, or greater than that of the tangible gift card prior to any transaction/conversion. Therefore, the card holder is prompted to indicate the value of the virtual card and this value is removed from the tangible card electronically via the central system computer just prior to creation of the virtual gift card. Thereafter, the central system computer electronically communicates to the user a virtual gift card when the on-line process is complete. In exemplary form, this virtual gift card may be downloaded from the central system computer and stored on the user's computer or mobile device, or emailed or otherwise communicated to the user. In the alternative, the central system computer may electronically transmit or make available the virtual gift card to another party designated by the user.

In exemplary form, the virtual gift card is an electronic version of a tangible gift card and includes the graphical information that would be present on the tangible gift card, except the information is provided in a visual electronic file. This virtual gift card also includes the embedded information necessary to use the virtual gift card as a financial instrument.

Referring back to step 622, the user may alternatively decide to use the authorization code to create a virtual gift card (via the kiosk or central system computer). This step 628 may be included to account for instances where the gift card giver has the authorization code, but has not yet used the code to create a tangible gift card. This step 628 may be utilized when the gift card giver learns that the gift card recipient would prefer a virtual gift card. Whether accessing the central system computer via the user's computer or via a kiosk, the user directs communications to the central system computer requesting generation of a virtual gift card by inputting the authorization code generated in step 622. The central system computer then verifies that the authorization code is valid and generates the virtual gift card.

Referring back to step 620, the user may alternatively decide to create a virtual gift card (via the kiosk or central system computer) without receiving an authorization code. At alternative step 630, the user indicates to the central system computer using the user's computer or kiosk that a virtual gift card is desired. Having already in its possession the information to verify that the virtual gift card may be created, the central system computer creates the virtual gift card and communicates this virtual card to the user or user's designated recipient. This communication may occur directly at the kiosk via a Bluetooth connection or other pairing between the kiosk and a wired or wireless device of the user or user's recipient. Alternatively, the kiosk or central system computer may email or otherwise electronically deliver the virtual gift card. As discussed previously, the virtual gift card includes the visual attributes of the tangible gift card and also includes the financial attributes to allow the virtual gift card to be utilized for payment of products/services.

Referring to FIGS. 17-21, each of the foregoing exemplary processes may make use of hardware and software that allows administrative oversight. In the context of a kiosk, this oversight may include, without limitation, locks associated with the kiosk housing to inhibit direct access to certain hardware of the kiosk, electronic locks to activate/deactivate certain features of the software or hardware, deletion rights, editing rights, and addition rights. In addition to many of these same oversight features for a central system or central system computer, additional administrative rights allow a hierarchy of control of the overall process and system. By way of example, there may be one or more chief administrators that have access to each and every possible control feature of the process and corresponding system. A subservient group may have administrative rights as it relates to a kiosk, but not as to the central system or central system computer. Those skilled in the art will readily understand that not everyone involved in the maintenance and day-to-day operation of the systems discussed herein needs to have the same administrative rights. Instead, as is common for a distributed system as described herein, administrative rights may be segmented to ensure only those persons with expertise in a particular area or function have administrative rights.

As shown in FIG. 17, this is a screen shot of a login screen for a management program. This login screen may be the same or different than those appearing on the visual display of a kiosk and visual displays communicatively coupled to the central system or central system computer. Nevertheless, for purposes of explanation, it is presumed that the login screen may be the same for all kiosks and central system devices. The login screen prompts an employee to input a user name and a password in order to gain access to the system (whether limited to the local system of a kiosk or anything up to all of the components of the system). Prior to logging in, the highest administrative rights person(s) may establish the requirements for logging on (or the architect of the system may establish these requirements) and what rights each subservient person shall have. Presuming the login information (user name and password) is currently submitted, the employee gains access to one or more parts of the system.

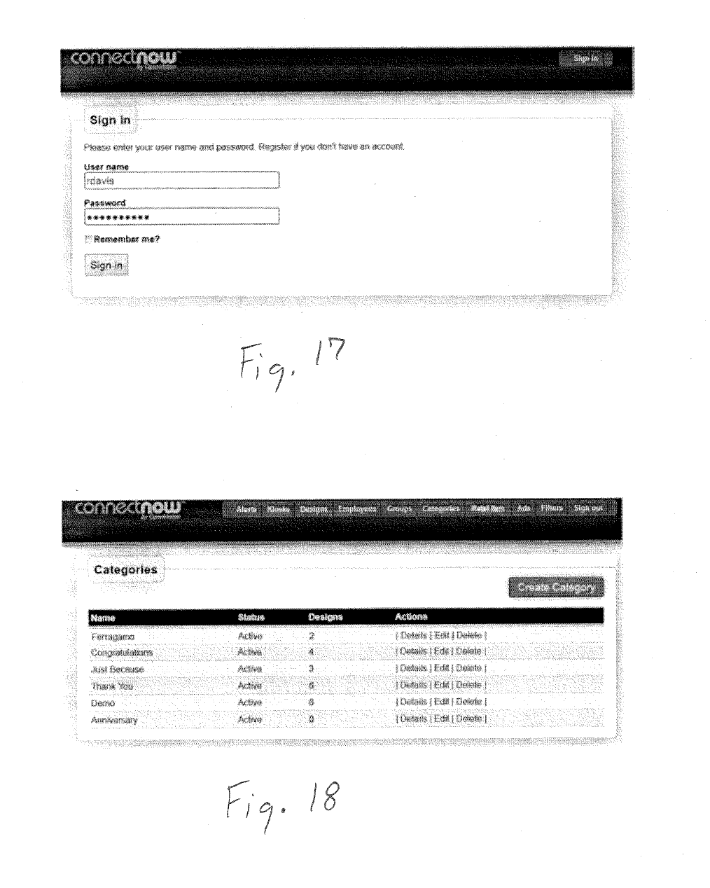

FIG. 18 shows a screen shot that may be visible by an authorized employee. This screen shots depicts a window where an authorized employee is able to create categories of gift card templates. For example, the authorized employee may construct several gift card templates that have a common theme corresponding to a particular category. In this case, the common themes have been shown in exemplary form to relate to greeting cards and include: (1) Congratulations; (2) Just Because; (3) Thank You; (4) Demo; (5) Ferragamo; and, (6) Anniversary. Accordingly, the authorized employee may create, delete, upload, or edit gift card templates having various predetermined graphics (including artwork and text). In this manner, the template operates as discussed previously to provide a virtual framework into which later graphics are merged to create a virtual gift card. And this screen not only provides a quick summary of the categories, but it also shows whether the categories are active or dead (Status), how many templates are present for each category (Designs), and the actions available to the employee (Actions).

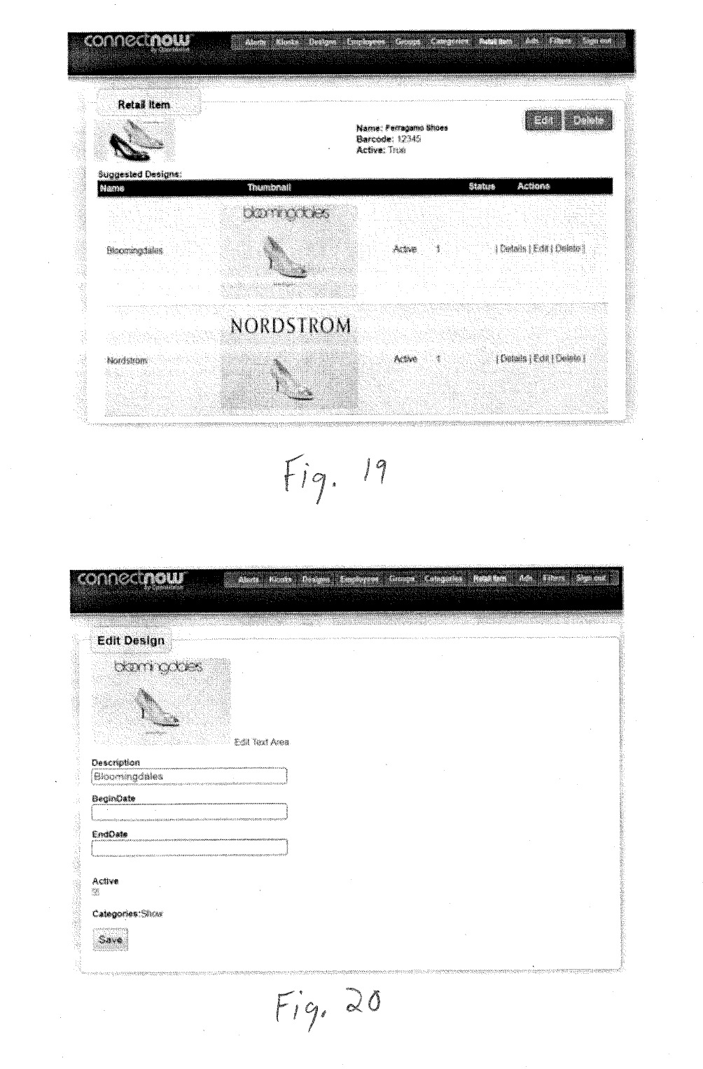

FIG. 19 is a screen shot after one clicks on the “Ferragamo” gift card template category. As can be seen, opening the “Ferragamo” gift card template category, the employee has access to two gift card templates. The first template of this category is titled “Bloomingdales”, while the second template is titled “Nordstrom”. In this example, whenever a customer scans or otherwise selects a Ferragamo shoes for intended purchase, one of these two templates is activated, depending upon the location of the kiosk (whether in Nordstrom or Bloomingdales). Both templates are identified as “Active” meaning that both templates are available either through a kiosk or through the central system computer. Not only are both templates “Active”, but the templates are able to be edited, deleted, and viewed to provide details regarding how often each template has been use, by whom, the amount associated with each card generated using the template, and other relevant details concerning utilization of the templates in commercial transactions. In exemplary form, editing of the template may include changing the graphic, the size of the graphic, and the size and font of the retail store name.

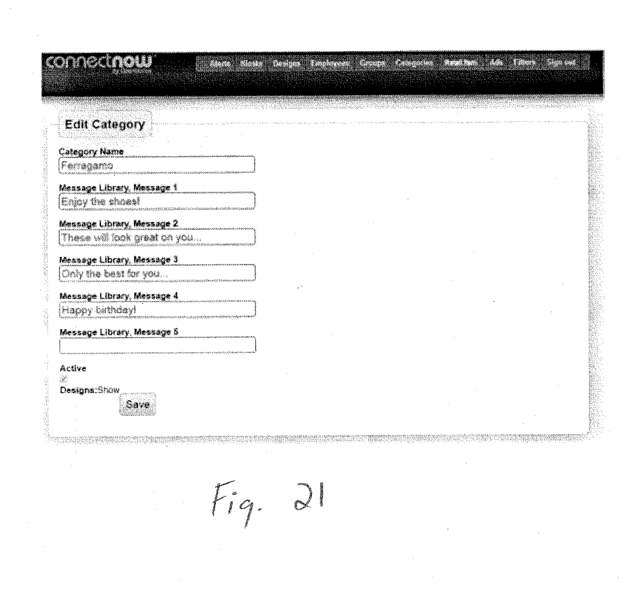

FIG. 20 is a screen shot showing certain editing features discussed with respect to FIG. 19. In particular, as shown in this screen shot, the authorized employee has attempted to edit the Bloomingdales template within the “Ferragamo” category. Specifically, the employee in this screen shot is able to change the title of the template, set date ranges for which the template will be active (BeginDate, EndDate), as well as a box that can be checked to maintain this template in active status as long as the Active box is checked.

FIG. 21 is a screen shot showing certain editing features discussed with respect to FIG. 19. In particular, as shown in this screen shot, the authorized employee has attempted to edit the Bloomingdales template within the “Ferragamo” category. Specifically, the employee in this screen shot is able to change the possible default/stock phrases/messages that go along with the Ferragamo shoe graphic, and maintain these phrases as “active” so long as the Active box is checked.

Following from the above description and invention summaries, it should be apparent to those of ordinary skill in the art that, while the methods and apparatuses herein described constitute exemplary embodiments of the present invention, the invention is not limited to the foregoing and changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A method of generating a gift card comprising:
receiving indicia corresponding to at least one of a product indicia representative of a particular product and a service indicia representative of a particular service;
making a gift card graphic available to the processing device that matches at least one of the product indicia and the service indicia;
merging the gift card graphics with a gift card template to create a virtual gift card;
recording the virtual gift card with a memory accessible by a kiosk that includes a gift card printer; and,
generating a receipt uniquely corresponding to at least one of the virtual gift card and a tangible gift card.

2. The method of claim 1, wherein:
the step of receiving the indicia includes receiving the product indicia representative of a particular product; and,
the particular product comprises a greeting card.

3. The method of claim 2, wherein:
the indicia includes at least of a bar code, a radio frequency identification tag, a universal product code, and an international article number code; and,
the indicia is integrated as part of the greeting card.

4. The method of claim 1, wherein:
the step of receiving the indicia includes receiving the product indicia representative of a particular product; and,
the particular product comprises a consumer product.

5. The method of claim 4, wherein:
the indicia includes at least of a bar code, a radio frequency identification tag, a universal product code, and an international article number code; and,
the indicia is integrated as part of the consumer product.

6. The method of claim 1, further comprising:
making available a communicative link between a user and the processing device that allows the processing device to receive at least one of the product indicia and the service indicia; and,
using the communicative link to receive instructions from the user to customize at least one of the virtual gift card and the tangible gift card.

7. The method of claim 6, wherein:
the step of making the gift card graphic available to the processing device includes communicatively coupling the processor to a database having a plurality of predetermined gift card graphics; and,
the step of making the gift card graphic available to the processing device includes conducting a search within the database for a gift card graphic that matches at least one of the product indicia and the service indicia.

8. The method of claim 7, wherein:
the database comprises a plurality of databases; and,
at least one of the plurality of databases is remote from the processing device.

9. The method of claim 7, wherein:
the processing device is incorporated into the kiosk;
the kiosk includes a user input device;
the kiosk includes the gift card printer; and,
the kiosk includes a receipt printer.

10. The method of claim 9, wherein:
the user input device includes at least one of a mouse, a trackball, a keyboard, a touch screen, a visual recognition screen, and a microphone; and,
the gift card printer includes a magazine to store gift card blanks.

11. The method of claim 9, wherein:
the kiosk includes a scanner; and,
the kiosk includes a card reader.

12. The method of claim 7, wherein:
the processing device includes a microprocessor incorporated into the kiosk; and,
the database is at least one of remote from the kiosk and associated with the kiosk.

13. The method of claim 1, further comprising:
prompting a user to assign an intended value to at least one of the virtual gift card and the tangible gift card; and,
receiving information from the user necessary to establish actual value of at least one of the virtual gift card and the tangible gift card.

14. The method of claim 1, further comprising:
accessing the virtual gift card in the memory responsive to prompting a user to enter information at the kiosk unique to the generated receipt; and,
using the virtual gift card to generate the tangible gift card using the gift card printer.

15. The method of claim 1, further comprising:
prompting a user to confirm that the indicia corresponds to at least one of an intended product for purchase and an intended service for purchase; and,
prompting the user to customize the virtual gift card.

16. The method of claim 15, wherein the step of prompting the user to confirm includes displaying an image representative of the indicia so as to allow visual confirmation that the indicia corresponds to at least one of the intended product for purchase and the intended service for purchase.

17. The method of claim 1, further comprising receiving a user input from a user to select at least one of a plurality of graphics, wherein the step of making a gift card graphic available includes making the plurality of graphics available, wherein each of the plurality of graphics match at least one of the particular product and the particular service.

18. The method of claim 1, further comprising:
prompting a user to at least one of establish and confirm a financial value of the virtual gift card; and,
communicatively coupling a user financial input with a financial clearinghouse to vest financial value in the virtual gift card.

19. The method of claim 18, wherein:
printing the tangible gift card using the gift card printer of the kiosk; and,
transferring the financial value of the virtual gift card to the tangible gift card by encoding the tangible gift card with financial information.

20. The method of claim 1, wherein:
the step of receiving the indicia includes scanning at least one of a product code and a service code; and,
the step of making the gift card graphic available to the processing device includes making available a visual representation of the gift card graphic to a user.

21. A method of generating a gift card comprising:
receiving indicia corresponding to at least one of a particular product and a particular service;
providing a plurality of graphic menus viewable using a visual screen to eventually create a virtual gift card;
searching for a gift card graphic that matches at least one of the particular product and the particular service;
prompting a user via at least one of the plurality of graphic menus to input an intended value for the virtual gift card;
merging the intended value with the gift card graphic that matches at least one of the particular product and the particular service prior to finalizing the virtual gift card; and,
generating at least one of a receipt uniquely corresponding to the virtual gift card and a tangible gift card corresponding to the virtual gift card.

22. The method of claim 21, wherein:
the step of receiving the indicia includes receiving the product indicia representative of a particular product; and,
the particular product comprises a greeting card.

23. The method of claim 22, wherein:
the indicia includes at least of a bar code, a radio frequency identification tag, a universal product code, and an international article number code; and,
the indicia is integrated as part of the greeting card.

24. The method of claim 21, wherein:
the step of receiving the indicia includes receiving the product indicia representative of a particular product; and,
the particular product comprises a consumer product.

25. The method of claim 24, wherein:
the indicia includes at least of a bar code, a radio frequency identification tag, a universal product code, and an international article number code; and,
the indicia is integrated as part of the consumer product.

26. The method of claim 21, further comprising:
making available a communicative link between a user and a processing device that allows the processing device to receive the indicia; and,
using the communicative link to receive instructions from the user to customize the virtual gift card.

27. The method of claim 26, wherein:
the step of searching for the gift card graphic includes communicatively coupling the processor to a database having a plurality of predetermined gift card graphics; and,
the step of searching for the gift card graphic includes locating within the database a gift card graphic that matches at least one of the indicia.

28. The method of claim 27, wherein:
the database comprises a plurality of databases; and,
at least one of the plurality of databases is remote from the processing device.

29. The method of claim 27, wherein:
the processing device is incorporated into a kiosk;
the kiosk includes a user input device;
the kiosk includes a gift card printer; and,
the kiosk includes a receipt printer.

30. The method of claim 29, wherein:
the user input device includes at least one of a mouse, a trackball, a keyboard, a touch screen, a visual recognition screen, and a microphone; and,
the gift card printer includes a magazine to store gift card blanks.

31. The method of claim 29, wherein:
the kiosk includes a scanner; and,
the kiosk includes a card reader.

32. The method of claim 27, wherein:
the processing device includes a microprocessor incorporated into a kiosk; and,
the database is at least one of remote from the kiosk and associated with the kiosk.

33. The method of claim 21, further comprising:
making available to a processor the gift card graphic that matches at least one of the particular product and the particular service; and,
merging the gift card graphic that matches at least one of the particular product and the particular service with a gift card template.

34. The method of claim 21, further comprising:
saving the virtual gift card in the memory configured to make accessible information concerning the virtual gift card using information from the receipt; and,
using the virtual gift card to generate the tangible gift card.

35. The method of claim 21, further comprising:
prompting a user to confirm that the indicia corresponds to at least one of an intended product for purchase and an intended service for purchase; and,
prompting the user to customize the virtual gift card.

36. The method of claim 35, wherein the step of prompting the user to confirm includes displaying an image representative of the indicia so as to allow visual confirmation that the indicia corresponds to at least one of the intended product for purchase and the intended service for purchase.

37. The method of claim 21, further comprising:
receiving a user input from a user to select at least one of a plurality of graphics;
making available the plurality of graphics available, wherein each of the plurality of graphics match at least one of the particular product and the particular service.

38. The method of claim 21, further comprising establishing a connection to a financial institution to vest the intended value of the virtual gift card, wherein the merging step occurs subsequent to the step of vesting the intended value of the virtual gift card.

39. The method of claim 38, wherein:
printing the tangible gift card using a gift card printer at a kiosk; and,
transferring the vested intended value of the virtual gift card to the tangible gift card by encoding the tangible gift card with financial information.

40. The method of claim 38, wherein:
the generating step includes generating the receipt and the tangible gift card;
the tangible gift card is generated using a gift card printer at a kiosk; and,
the tangible gift card is encoded with financial information using information accessible using the receipt.

41. A device for generating gift cards, the device comprising:
a kiosk housing;
a display device;
a gift card printer;
a user input device configured to detect indicia specifically identifying a least one of a particular product and a particular service;
a processor communicatively coupled to the display device and a database, the processor running software operative to retrieve matching graphic data from the database corresponding to at least one of the particular product and the particular service, the software also operative to generate a series of menus displayed on the display device and to cause display of an image representative of the matching graphic data accessed from the database.

42. The device of claim 41, further comprising at least one of a camera and a scanner communicatively coupled to the processor.

43. The device of claim 41, wherein the user input device comprises at least one of a mouse, a trackball, a keyboard, a touch screen, a visual recognition screen, and a microphone.

44. The device of claim 41, wherein the user input device comprises at least one of a scanner and a camera.

45. The device of claim 41, further comprising a user input payment device comprising a payment card reader.

46. The device of claim 41, further comprising a user output device comprising a receipt printer.

47. A virtual gift card generating computer comprising:
a microprocessor web server communicatively coupled to a database storing a plurality of graphic information corresponding to at least one of a specific product and a specific service, the microprocessor web server running software operative to retrieve matching graphic data from the database corresponding to at least one of the particular product and the particular service, the software also operative to generate a series of menus adapted to be displayed on a user display device, the microprocessor web server configured to save a virtual gift card and generate a receipt including information sufficient to cause retrieval of the saved virtual gift card by a device remote from the microprocessor web server.

48. A method of generating a gift card comprising:
fielding an inquiry from a user attempting to locate at least one of a product and a service the user contemplates purchasing;
making available to the user at least one graphic corresponding to at least one of the product and the service the user contemplates purchasing;
making information available to the user concerning a retailer offering for sale at least one of the product and the service the user contemplates purchasing; and,
generating at least one of a tangible gift card and a virtual gift card including the at least one graphic representative of at least one of the product and the service the user contemplates purchasing, where at least one of the virtual gift card and the tangible gift card is redeemable only at the retailer.
